(19) United States
(12) Patent Application Publication
(10) Pub. No.: US 2014/0172751 A1
(43) Pub. Date: Jun. 19, 2014

(54) METHOD, SYSTEM AND SOFTWARE FOR SOCIAL-FINANCIAL INVESTMENT RISK AVOIDANCE, OPPORTUNITY IDENTIFICATION, AND DATA VISUALIZATION

(71) Applicant: GREENWOOD RESEARCH, LLC, Andover, MA (US)

(72) Inventor: Floyd S. Greenwood, Andover, MA (US)

(73) Assignee: GREENWOOD RESEARCH, LLC, Andover, MA (US)

(21) Appl. No.: 14/107,860

(22) Filed: Dec. 16, 2013

Related U.S. Application Data
(60) Provisional application No. 61/737,747, filed on Dec. 15, 2012.

(51) Int. Cl. G06Q 40/06; G06Q 50/00

(52) U.S. Cl. CPC G06Q 40/06; G06Q 50/01
USPC 705/36 R

(57) ABSTRACT

Method, system and software for social-financial investment risk avoidance, opportunity identification, and data visualization, which can use social data with other data to generate and present new types of data, which can be used by investors to make investment decisions, which can include a scoring model, which can help users identify trends and/or interpret and synthesize large amounts of data based on social data and other data, which can include an interactive, graphical user interface, which allows users to explore and examine social data and other data that can impact, for example, the investment performance of a company's stock, and which can include the ability to click on any word or point on a line plotted over time to see additional information constructs, where the social data can be illustrated via numeric scores, line and scatter plots, word clouds, word radials, gauges and the like.

### CROSS-REFERENCE TO RELATED APPLICATION

This application claims the benefit of, and priority to, U.S. Provisional Patent Application No. 61/737,747, filed on Dec. 15, 2012, entitled “Social-Financial Investment Risk Avoidance, Opportunity Identification, and Data Visualization Tool,” the entire disclosure of which is hereby incorporated herein by reference.

### TECHNICAL FIELD

The present invention is in the technical field of investment research. More particularly, the present invention is in the technical field of investment research using social data, to assist in making financial investment decisions, and using social data with other large scale online data, particularly data sets to assist in making financial investment decisions.

### BACKGROUND OF THE INVENTION

Conventional investment research incorporates a broad range of financial, economic, and company specific factors. Conventional investment research does not utilize the information embedded in social data or social data incorporated with other large datasets such that the present invention utilizes in order to anticipate company revenue growth trends or asset price changes.

Prior work has been done to establish connections between financial markets and social type data. For example, as published in Journal of Computational Science, 2(1), March 2011, Pages 1-8, Bollen, Mao and Zeng find that mood as calculated on Twitter can help predict changes in the price of the Dow Jones Industrial Average (DJIA) over several days. Other work has found connections between stock related message boards and micro blogs and short-term stock trading. All of the previous work is narrow in scope and either focuses on broad market movements or collecting stock advice from other market participants.

Reference 1: Journal of Computational Science, 2(1), March 2011, Pages 1-8 “Twitter mood predicts the stock market,” by Johan Bollen, Huina Mao, Xiao-Jun Zeng. Submitted Oct. 14, 2010. In this research piece, the authors find that they can anticipate changes in the price of the Dow Jones Industrial Average (DJIA) several days ahead of time by modeling public mood based Twitter postings. The present invention extends considerably beyond this work in at least four ways. 1. Bollen looks at a generalized outcome that is predicting the broad market trend, but not specific stocks. The present invention makes predictions about specific companies, stocks, other assets. 2. Bollen uses a single input, Twitter. The present invention incorporates a wide range of inputs, including, but not limited to Twitter. 3. Bollen is focused on a relatively short time horizon of several days. The present invention looks over a longer period of time. 4. The present invention creates an entire framework for harvesting and incorporating social data in investment risk avoidance, opportunity identification, and related data visualization. The Bollen work provides a useful construct and establishes that social data can be predictive in determining asset prices.

Reference 2: “Predicting Financial Markets: Comparing Survey, News, Twitter and Search Engine Data,” by Huina Mao, Scott Counts, and Johan Bollen Dec. 5, 2011 (arXiv:1112.1051). In this research piece, the authors explore the predictive power of Twitter versus news, survey, and search engine data to predict the overall mood of financial markets. This work is focused on predictions of the overall market. The present invention is focused on specific assets, uses a broader set of inputs, and creates a broadly useful platform for incorporating this data in real life decision making.

Reference 3: Proceeding WI-IAT '10 Proceedings of the 2010 IEEE/WIC/ACM International Conference on Web Intelligence and Intelligent Agent Technology—Volume 01 Pages 492-499: “Predicting the Future With Social Media,” by Sitaram Asur and Bernardo A. Huberman Mar. 29, 2010. In this research piece, the authors find that they can predict movie box office sales using Twitter data. They also found that they could anticipate prices on the HSX exchange. This is a website that allows participants to buy and trade in movies. Movie prices are driven by box office sales. While this work is limited to a single social data source, Twitter, and it deals with movies rather than asset prices, it provides constructive evidence as to the use of social data in predicting prices and in predicting consumer activity.

Reference 4: Social Science Research Network: “Predicting Break-Points in Trading Strategies with Twitter,” by Arnaud Vincent and Margaret Armstrong Oct. 2, 2010. In this research piece, the authors find that Twitter data can be useful in identifying break points (or price changes) in foreign exchange (currency) prices over short time periods. This work is much narrower in scope than the present invention.

Reference 5: The Journal of Finance Vol. 59, No. 3, June 2004: “Is All That Talk Just Noise? The Information Content of Internet Stock Message Boards”, by Werner Antweiler and Murray Z. Frank. In this research piece, the authors find a connection between messages posted on Yahoo Finance and Raging Bull and DJIA share price volatility and share price. The authors find that stock messages help predict market volatility. Their effect on stock returns is statistically significant but economically small. The present invention extends considerably beyond this work. This work focuses on a single source and is focused on stock specific discussion. The present invention is focused on a broad range of sources and is focused on company products and services, and only secondarily incorporates ticker related discussion.

Reference 6: BusinessWeek 2009. StockTwits may change how you trade, BusinessWeek (online edition), February 11. StockTwits provides a mechanism for users to Tweet their views on specific tickers. The present invention serves a different purpose. The present invention makes predictions of stock prices and company revenue based on social data measures of company fundamentals, by harnessing social data to measure, among other things, consumer interest in the company's shares. StockTwits utilizes the collective comments of people investing in the stocks themselves.

### SUMMARY OF THE INVENTION

The present invention is a computerized tool (hereinafter, the “present invention”) for users to identify investment opportunities and to avoid risks with current investments. This invention is an investment tool that incorporates analysis of social data and analysis of social data with other big data sets into financial investment decisions.

The present invention is distinct from and additive to known prior work, and solves problems not addressed in prior work. The present invention incorporates a wide range of social data types and generates stock specific information based on social data indicators relative to the company's products and services. In doing so, it creates a more universal and more robust mechanism for anticipating not only share price movements, but also top line revenue trends. At the same time, the present invention is a tool that allows ordinary investors, not just statisticians and quantitative traders to incorporate social data in their investment decisions.

The present invention is a comprehensive tool to harness social data in stock and other asset investing. It addresses several major problems in one place.

The present invention gives users the ability to understand the important information embedded in social data relative to specific companies across a broad range of companies. The present invention predicts revenue and earnings trends for companies and ties this to share price movements by modeling companies to the social and other internet data that relates to its products and services. Previous work relies on the collective wisdom of other investors or on narrow sets of input data.

The present invention takes complex unstructured data as an input and generates easy to utilize and interpret scores that any investor can incorporate into investment and other decisions.

The present invention gives users multiple ways to understand the underlying social drivers of a specific company or asset.

The present invention provides a series data visualization tools that are novel for the use of and understanding of social data as it relates to financial data.

The present invention provides an easy way for the system administrator to easily refine company specific models without requiring advanced statistical tools.

The present invention provides a unified way to collect and model all of the relevant social and internet data sources for specific companies. It also provides a robust method for collecting this data, and is readily adaptable as new data sources become available.

The present invention provides an easy to use user interface to map data to companies and to fine tune the scoring process for specific companies. In doing so, complex data input maps can be easily created for individual companies.

The present invention allows users to track specific user-entered portfolios of assets.

The present invention creates active user alerts when changes occur to relevant stocks. These alerts occur via web interface, email, and text message.

The present invention has been shown to have good predictive results for company reported revenue, company share price, and company growth and sales outlooks The present invention has also been shown to have good predictive results specific category and product sales, sales drivers, and consumer sentiment about companies, brands, and products.

The present invention allows users to understand the fundamental drivers and health of companies and assets.

The present invention monitors the volume of discussion and other activity relative to a company's products and services. For instance, are more people interested in a product or company or are fewer people interested in it?

The present invention identifies company revenue trends before the information is released by the company being analyzed or otherwise known by the market.

The present invention uses social and other big data as a way to estimate whether demand for a company's products is increasing or decreasing by looking at the volume, nature, and sentiment. For example, is the sentiment getting more positive or more negative?

The present invention uses social and other big data to gauge the market climate for a company's products and services, as well as the near-term sentiment about a company's stock.

The present invention uses social and other big data to identify changes in the market that could positively or negatively impact a company's products and/or stock price, or changes in company actions that could positively or negatively impact a company's products and/or stock price

The present invention provides investors with alerts indicating trend changes or opportunities to buy or sell stock based on changes in the data on specific companies or the present invention algorithms.

Social data includes without limitation: (1) purely social data, which includes usage counts, sentiment, and raw text from social media websites such as Twitter, Facebook, Instagram, YouTube, and Pinterest; (2) other commentary type data such as that on blogs, discussion forums and review sites; and (3) transactional type data, such as site traffic and search engine trend data.

In one aspect, provided herein is a computer implemented method comprising: on a device having one or more processors and a memory storing one or more programs for execution by the one or more processors, the one or more programs including instructions for: collecting data from an information source regarding a target; generating a signal related to the target based on the collected data; and transmitting the signal.

In one embodiment of this aspect, the method further comprises: parsing the data; and scoring the data, wherein the generating is based on the parsed and scored data.

In another embodiment of this aspect, the information source comprises one from the group consisting of a social media website, Twitter, Facebook, Instagram, Pinterest, YouTube, LinkedIn, Google Plus+, Tumblr, blogs, discussion forums, review sites, site traffic and search engine trend data.

In another embodiment of this aspect, the target comprises one from the group consisting of a security, a publicly traded security, a company, an organization, a product, a service, real property, a vehicle, a new automobile, a used automobile, audiovisual content, a website, a movie, a television show, a song, a publication, a book, a magazine and a newspaper

In another embodiment of this aspect, the signal comprises one from the group consisting of a social data trend indicator, a sentiment score, a star rating, a traffic light indicator, a linear score, a composite score, a chart having an x-axis and a y-axis, a trend line, an indexed trend line, a gauge, a meter, a sentiment gauge, a sentiment meter, a color coded indicator, an alert, a text radial, an interactive text radial, a pop up window, a window with tabs, a word cluster, a heat map and a color coded map.

In another embodiment of this aspect, the signal is based on a calculation based on one from the group consisting of social data, news data, transaction based data, company disclosed data and market data, and the calculation is one from the group consisting of a growth rate, a sentiment, a sentiment ratio and an influence score.

In another embodiment of this aspect, the signal is a user alert, and the user alert comprises one from the group consisting of a change in a calculated score, an anticipated change in a revenue trend for the target, a change in a sentiment of a discussion about the target's underlying products based on a calculation, a change in a volume of a discussion relating to the target, a change in a calculated interest in the target, a change in a tone of news headlines relating to the target, a change in a volume of news headlines relating to the target, a drop or increase in site traffic relating to the target relative to a calculated expectation, a changes in a calculated expectation of a litigation risk based on a litigation section of a recent SEC filing related to the target, and an upcoming earnings release.

In another embodiment of this aspect, the parsing comprises prompting a user to select one or more basic terms; and parsing company generated text and website keywords for words and phrases that are unique to the one or more basic terms.

In another embodiment of this aspect, the parsing comprises a process of collecting information regarding an other target, comparing information relating to the target with information relating to the other target, and identifying words and phrases which are most unique to the target relative to the other target.

In another embodiment of this aspect, the scoring comprises prompting a user to score a sentiment and a relevance of an individual piece of information from the parsed data.

In another embodiment of this aspect, the scoring comprises: developing a descriptive model for the target; generating a factor based on the descriptive model; normalizing the factor using a standard statistical technique; prompting a user to select a factor; prompting the user to select a weight or a lag for the selected factor; and calculating a score based on the selected weight or lag for the selected factor.

In another embodiment of this aspect, the factor comprises one from the group consisting of volume of social media output, count of social media output, Facebook likes, a sentiment score for text based data, average sentiment, a ratio of sentiment, positive sentiment, negative sentiment, a sentiment scoring parameter for the target, a sentiment scoring parameter for a topic related to the target, a rate of change, a change relative to the target's competitor, and an intermediate computed factor.

In another embodiment of this aspect, the transmitting comprises transmitting an image comprising a name of the target, a ticker symbol corresponding to the target, a share price relating to the target, a social data trend relating to the target based on a score generated by the scoring, a traffic light signal and a composite score over time based on a score generated by the scoring expressed as a line on a chart.

In another embodiment of this aspect, the transmitting comprises transmitting an image comprising a name of the target, a ticker symbol corresponding to the target, a share price relating to the target, a social data trend relating to the target based on a score generated by the scoring, a traffic light signal and a sentiment gauge.

In another embodiment of this aspect, the transmitting comprises transmitting an image comprising a name of the target, a ticker symbol corresponding to the target and a star rating for the target based on the scoring.

In another embodiment of this aspect, the transmitting comprises transmitting an image comprising a name of the target, an interest score for the target, a system generated alert, a meter, a model input explorer and a current discussion explorer.

In another embodiment of this aspect, the transmitting comprises transmitting an image comprising a text radial related to the target, and the text radial is interactive and is adapted to allow a user to click on a portion of the text radial to obtain additional information regarding one or more subjects presented in the text radial.

In another embodiment of this aspect, the transmitting comprises transmitting an image comprising a stock price chart related to the target, and the stock price chart is interactive and is adapted to allow a user to click on a portion of the stock price chart to obtain additional information regarding one or more subjects presented in the stock price chart at a particular point in time.

In another aspect, provided herein is a computer system comprising: one or more processors; and memory to store: one or more programs, the one or more programs comprising instructions for: collecting data from an information source regarding a target; generating a signal related to the target based on the collected data; and transmitting the signal.

Each of the various embodiments of the aspect detailed above and herein can also be embodiments of the computer system.

In another aspect, provided herein is a non-transitory computer-readable storage medium storing one or more programs configured to be executed by one or more processing units at a computer comprising: instructions for: collecting data from an information source regarding a target; generating a signal related to the target based on the collected data; and transmitting the signal.

Each of the various embodiments of the aspect detailed above and herein can also be embodiments of the non-transitory computer-readable storage medium.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

In the drawings, where like reference numerals refer to like reference in the specification:

FIG. 1 illustrates an example of System Architecture according to the present invention;

FIG. 2 illustrates an example of Data Collection and Correction System according to the present invention;

FIG. 3 illustrates an example of Sentiment Training System—Initial Human Scoring Web Interface, by which initial human scoring of text can be completed, according to the present invention;

FIG. 4 illustrates an example of Analysis Subsystem and Scoring Subsystem Architecture according to the present invention;

FIG. 5 illustrates an example of Sample Factors and Manual Weighing Interface, by which factors can be dragged and dropped from one box to the other and weightings can be adjusted via slider bars within each box, according to the present invention;

FIG. 6 illustrates an example of Scoring Process After Model Calculation according to the present invention;

FIG. 7 illustrates an example of Traffic Light Score With Total Interest Line according to the present invention;

FIG. 8 illustrates an example of Traffic Light Score, which can have activity and sentiment levels of consumers of company products and with investors in the company stock, according to the present invention;

FIG. 9 illustrates an example of User Interface Workflow according to the present invention;

FIG. 10 illustrates an example of a Screen Shot of Stock Screening Graphical Interface, which is an example of the interface users can utilize to screen stocks, according to the present invention;

FIG. 11 illustrates an example of a Screen Shot of Company/Stock Specific Analysis Dashboard according to the present invention;

FIG. 12 illustrates an example of Company/Stock Dashboard 2 according to the present invention;

FIG. 13 illustrates an example of a Screen Shot of Text Radials To Illustrate Frequent Words, in which text radials are used to illustrate words frequently associated with a topic, according to the present invention;

FIG. 14 illustrates an example of a Screen Shot with a Click to Learn More Chart Feature according to the present invention;

FIG. 15 illustrates an example of a Screen Shot with a Click on stock price chart to see discussion leading up to that point in time, according to the present invention;

FIG. 16 illustrates an example of a Screen Shot with SEC Filing Text Presented as a Word-Cloud, which illustrates an example of the display of frequently used words associated with a topic in a cloud of words, with larger fonts showing greater frequency of use, according to the present invention;

FIG. 17 illustrates an example of a Screen Shot with a Facebook Trend Analysis, which illustrates an example of the display of trends in Facebook “Likes” and “Talking About Counts, according to the present invention;

FIG. 18 illustrates an example of a Screen Shot with Compare Multiple Twitter Streams, which illustrates an example of the ability to compare multiple Twitter Streams showing word frequency, sentiment, and volume, according to the present invention;

FIG. 19 illustrates an example of a Screen Shot with a Sentiment Gauge according to the present invention;

FIG. 20 illustrates an example of a Screen Shot with Compare Discussion Volume and Sentiment, which illustrates an example of the display of discussion frequency and aggregate sentiment over time, according to the present invention;

FIG. 21 illustrates an example of a Screen Shot with Discussion Mapped To Geographic Locations, which illustrates an example of the use of geo-tagging and mapping in the display and analysis of data, according to the present invention;

FIG. 22 illustrates an example of a Screen Shot with Real Estate Analysis, which illustrates an example of the tools available to users to compare real estate markets, according to the present invention;

FIG. 23 illustrates an example of a Screen Shot with Compare Company Site Traffic to that of its Competitors, which illustrates an example of the user ability to compare site traffic for companies and groupings of web sites according to the present invention; this also illustrates an example of the comparison of a company's web site traffic to that of its competitors, according to the present invention;

FIG. 24 illustrates an example of a Screen Shot with Online Product Review Trends according to the present invention;

FIG. 25 further illustrates an example of Company/Stock Dashboard 2 according to the present invention;

FIG. 26 illustrates the iterative regression approach that can be used to set initial model weights and factors;

FIG. 27 illustrates an example of the present invention ranking company brands by a social input;

FIG. 28 illustrates a display of a company's competitors and those companies' competitors according to the present invention; and

FIG. 29 illustrates a display of relative mindshare among consumers of various companies in an industry according to the present invention.

### DETAILED DESCRIPTION

It should be understood that this invention is not limited to the particular methodology, protocols, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities used herein should be understood as modified in all instances by the term “about.”

All publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

### SOME SELECTED DEFINITIONS

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities used herein should be understood as modified in all instances by the term “about.” The term “about” when used in connection with percentages may mean±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

To the extent not already indicated, it will be understood by those of ordinary skill in the art that any one of the various embodiments herein described and illustrated may be further modified to incorporate features shown in any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

The invention is a social-financial investment risk avoidance, investment opportunity identification, and data visualization tool. It is designed for investors in stocks, bonds, options, and real estate (collectively referred to as “assets”).

The present invention incorporates the use of social data in making investment decisions. It also incorporates the use of social data with other big data as described in this document. It provides a score for individual stocks to help investors make investment decisions and interpret and synthesize large amount social data and large amounts of social data with other data. The score also helps investors to determine which assets are likely to rise and fall based on this data and provides a number of other useful data insights. Furthermore, the present invention provides an interactive, graphical user interface that allows users to explore and examine social data and other data that will impact the investment performance of a company's stock.

The score can be presented in three ways, for example, as follows: 1. A social-financial star rating system: 1-5 stars. 2. A social-financial traffic light. 3. A line plot graph showing growth in the present inventions composite raw score calculation normalized to a fixed point in time. The line plot can show a projection beyond the current date.

The present invention can help investors in two ways, for example, as follows: 1. It anticipates company revenue trends. 2. It anticipates asset price movements.

With the present invention, users can study stocks and related companies relative to social metrics described in this document, avoid investment risk, identify investment opportunities, and analyze datasets via visual and interactive tools. The user can also use the present invention to perform similar analysis on real estate and other related asset classes.

TABLE 1
Primary Data Types Incorporated within the Present Invention

| Data Type | Description |
|---|---|
| Social Data | Social data is data generated by people using the internet. It includes |
| | discussion, comments, blog postings, and other publicly available |
| | interactions by and among internet users. This includes usage via |
| | computers, mobile telephones, other mobile devices, and other web- |
| | connected devices. Twitter, Facebook, Instagram, YouTube, Tumblr, |
| | Google Plus+, Flickr, MySpace, LinkedIn, and Pinterest are examples |
| | of social content websites and services. |
| News Data | This includes news headlines and stories. |
| Transaction Based Data | This is data that arises out of people doing something other than |
| | social data above. This includes ecommerce data, real estate sales, |
| | and other data generated as a result of a purchase or sale activity. It |
| | also includes data such as site traffic estimates and search engine |
| | results and counts. |
| Company Disclosed | This is filing, reporting, and other company presented information. |
| Data | This includes SEC filings and related financial statement data, |
| | company earnings releases, company news releases, and company |
| | marketing and product information. |
| Market Data | This includes stock prices, trading volumes, and related asset prices. |
| | This also includes market expectations for earnings and revenue. |
| Calculated Data | Using various statistical methodologies, the present invention |
| | incorporates data that is computed from the above sources. This |
| | includes growth rates, sentiments, sentiment ratios, influence scores, |
| | and the like. |

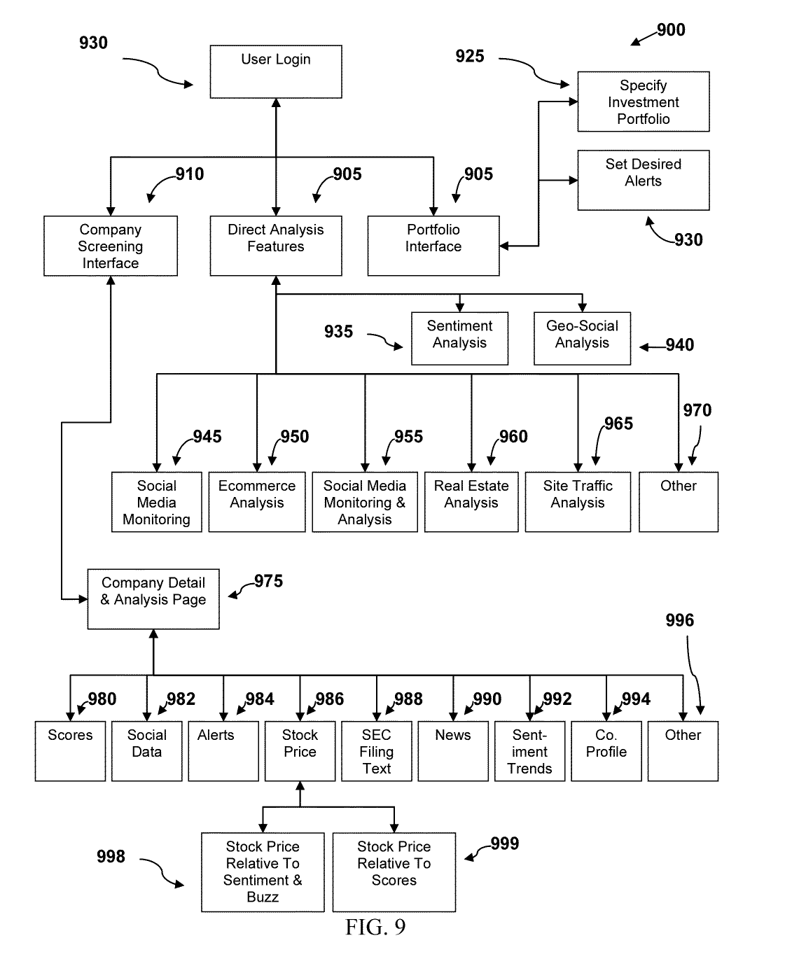

The present invention presents information to the user in two primary ways. The first is an interactive web based user interface (FIG. 9). This interface can be accessed via any modern web browser from any web connected device.

The second is via user configurable alerts. These alerts are related to changes in the social financial factors that the present invention tracks and the scores and other statistics that the present invention calculates. These scores can be delivered via electronic mail, text message, or web browser.

TABLE 2
Examples of User Alerts Generated by Present Invention

```
1. Changes in scores calculated by present invention.
2. Anticipated changes in revenue trends for specific companies.
3. Changes in the sentiment of discussion about the company's
  underlying products as calculated by present invention.
4. Changes in the volume of discussion or interest in the company
  and its products.
5. Changes in the sentiment or volume of news headlines.
6. A drop or increase in specific inputs, for example site traffic or
  Twitter volume, relative to the present invention's
  calculated expectations.
7. Changes in the present invention's calculated expectation of litigation
  risk based on the litigation section of recent SEC filings.
8. Upcoming earnings releases or other events.
```

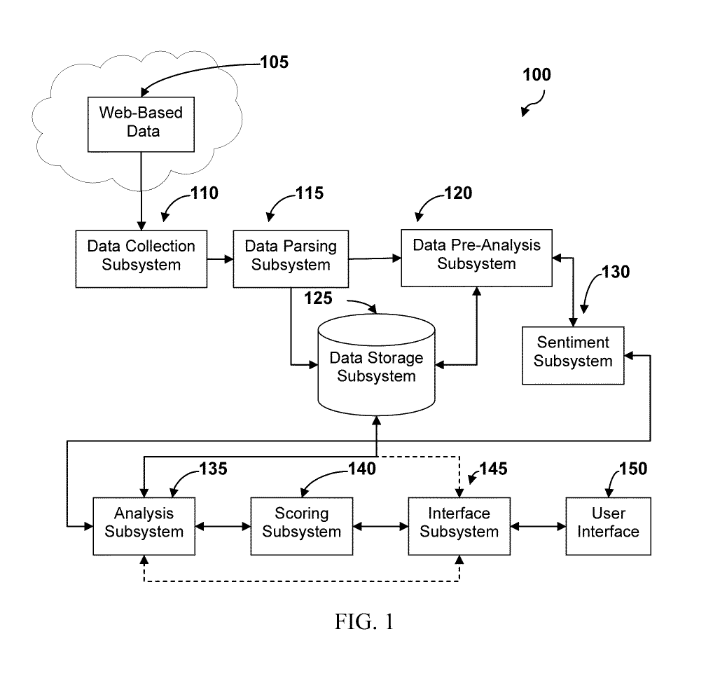

The present invention works based on the components illustrated in FIG. 1 and in following figures and described below.

The present invention can have a system architecture 100 such as that depicted in FIG. 1. Specifically, the system architecture 100 can include a data collection subsystem 110 adapted to receive web-based data 100. The data collection subsystem 110 can be adapted to send information to a data parsing subsystem 115, which can be adapted to send information to a data pre-analysis subsystem 120 and a data storage subsystem 125. The data storage subsystem 125 can send and/or receive information to/from the data pre-analysis subsystem 120. The data storage subsystem 125 can send and/or receive information to/from an analysis subsystem 135. The data storage subsystem 125 can optionally send and/or receive information to/from an interface subsystem 145. The data pre-analysis subsystem 120 can send and/or receive information to/from a sentiment subsystem 130. The sentiment subsystem 130 can send and/or receive information to/from the analysis subsystem 135, which can send and/or receive information to/from a scoring subsystem 140, which can send and/or receive information to/from the interface subsystem 145, which can send and/or receive information to/from a user interface 150. The analysis subsystem 135 can optionally send and/or receive information to/from the interface subsystem 145.

Data Collection Subsystem

The data collection subsystem 110 can use a variety of methods to obtain large amounts of data from remote sources. These include screen scraping, request and streaming API interfaces, FTP methods, database connections and the like.

The present invention includes methods to efficiently collect data. Without limitation, these include data collection randomization and a self-learning data identification process. Data randomization helps to ensure good sampling and helps to balance network loads. The self-learning feature helps to make the process more robust. As website data structures change, the system compares new data to data already collected to identify potential problems with data structure. The system then attempts to adapt. It does this by slightly modifying the data parsing and collecting specifications in a stepwise manner, and then iteratively comparing the results to the previously collected sample. It also alerts the administrator via email to changes to allow for more significant modifications.

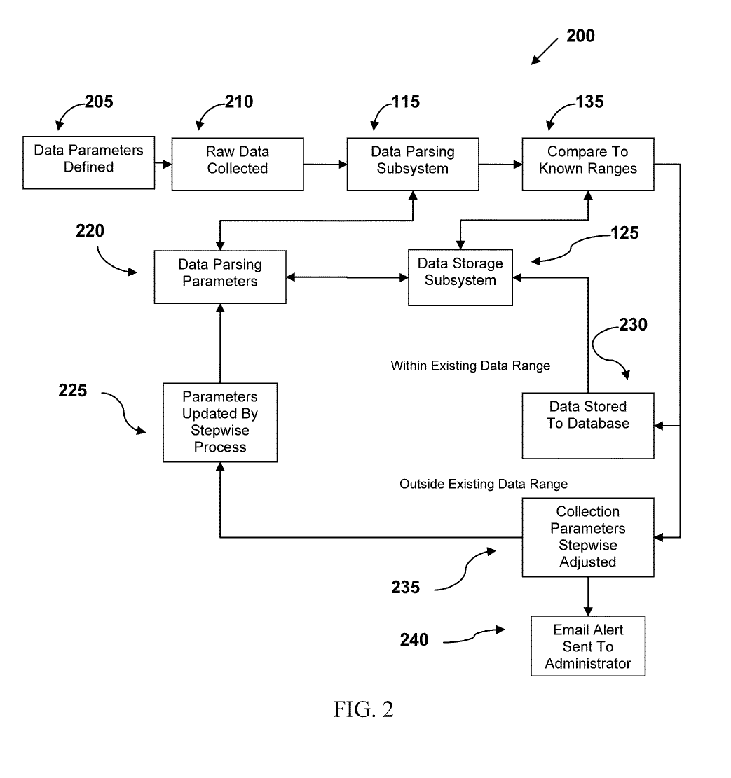

The present invention can have a data collection and correction system 200 such as that depicted in FIG. 2. Specifically, the data collection and correction system 200 can include the data parsing subsystem 115 and the data storage subsystem 125. In a data collection and correction process, data parameters can be defined 205 and raw data can be collected 210, which may be based on the defined data parameters from step 205. The collected raw data based on defined data parameters from steps 205 and 210 can be input into the data parsing subsystem 115. The data parsing subsystem 115 can send and/or receive data parsing parameters before or after a step of determining data parsing parameters 220. Data from the data parsing system 115 can be compared to known ranges 215. Also, the data storage subsystem 125 can send and/or receive information before or after the step of comparing information to known ranges 215. After the step of comparing information to known ranges 215, if the information is within an existing data range, data can be stored 230 in the data storage subsystem 125. Alternately, after the step of comparing information to known ranges 215, if the information is outside the existing data range, a step of collecting stepwise adjusted parameters 235 can be performed. After the step of collecting stepwise adjusted parameters 235, an email alert can be sent to an administrator 240 or parameters can be updated by a stepwise process 225. After the update by the stepwise process 225, the step of determining data parsing parameters 220 can be performed. After the step of determining data parsing parameters 220, information can be sent or received to/from the data parsing subsystem 115, as noted above, or to/from the data storage subsystem 125.

Data Parsing Subsystem

The data parsing subsystem 115 handles raw data parsing, selection, and filtering. The data parsing subsystem can be implemented using PHP, Python and Java programming languages.

Data selection and filtering is necessary to ensure that the present invention is considering the correct data. For example when evaluating the stock of the Apple Inc. (the maker of iPhones, etc.), discussion about apple pies should not be considered.

The present invention can use three processes to determine correct search terms and bad term omission, for example, as follows: 1. A human enters basic terms. 2. The present invention parses company generated text, such as SEC filing descriptions, and website keywords for words and phrases that are unique to that term. The process involves collecting text from other companies and then isolating words and phrases which are most unique to the target company. 3. The present invention uses a natural language scoring system that is similar to sentiment subsystem 130 to determine relevance. A human trains a sample set and then the present invention uses this set to create a set of rules for scoring future text.

Text parsing is done using industry accepted text parsing techniques.

Data Pre-Analysis Subsystem

The data pre-analysis subsystem 120 handles initial data analysis, the results of which are stored in the database. This includes summarizing data, performing general sentiment analysis, and calculating basic statistics such as counts and averages. This allows information to be stored for more efficient retrieval later in the process and help to balance the server load.

At this stage the following, without limitation, can be calculated and stored: 1. General sentiment on text. 2. Word and frequency counts. 3. Growth rates and rates of change. 4. Averages, ranges, and other statistical measures.

At this stage, all calculations are done based on generalized parameters. Later, in the analysis subsystem 135, described below, analysis is done based on specific user inputs, generally based on the information that is calculated at this stage.

Data Storage Subsystem

In the data storage subsystem 125, data can be stored in a relational database and in flat files spread across multiple disks and servers for load balancing and fault protection. The data storage subsystem can be implemented using MySQL databases, using industry best practices.

Whenever possible calculations are batch processed and stored in the database for later retrieval to improve overall system performance.

Sentiment Calculation Subsystem

The sentiment subsystem 130 calculates sentiment scores on raw text. All text receives a sentiment score to indicate whether it is positive or negative relative to the topic. The present invention uses accepted industry natural language processing practices for determining sentiment. First, a human scores a sample of phrases as positive or negative. This creates a training set. The algorithm within the present invention then creates a set of rules for scoring future text. Calculations can be conducted using PHP and Python programming languages.

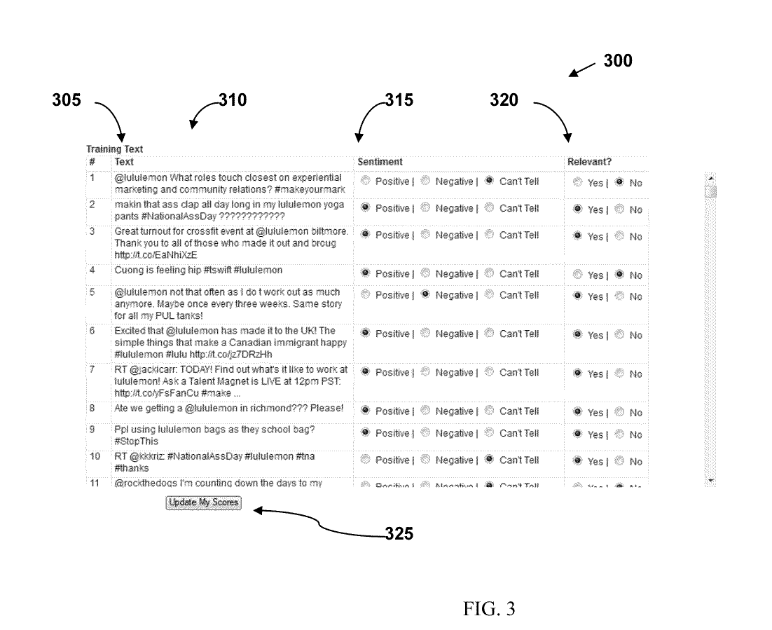

The present invention can have a sentiment training system with an initial human scoring web interface 300 such as that depicted in FIG. 3. Specifically, the interface 300 can have a training number field 305, a text field 310, a sentiment field 315, a relevance (“Relevant?”) field 320 and an “Update My Scores” button 325. The interface 300 can include a vertical slide bar (right side of FIG. 3). The training number field 305 can include a sequential list of numbers, here 1 to 11, for example. The text field 310 can include social media information such as information from Twitter as shown in FIG. 3. The sentiment field 315 can prompt a user to select the user's sentiment for the given piece of information displayed in the text field 310 by selecting a radio button associated with “Positive”, “Negative” or “Can't Tell”. Also, the relevance field 320 can prompt the user to select whether the given piece of information displayed in the text field 310 is relevant or not by selecting a radio button associated with “Yes” or “No”. Once the user completes selection of the various prompts in the sentiment field 315 and the relevance field 320, the user can click on the “Update My Scores” button 325 to submit the information for further processing. Once the model is trained, the sentiment scoring system can be implemented in Python programming language.

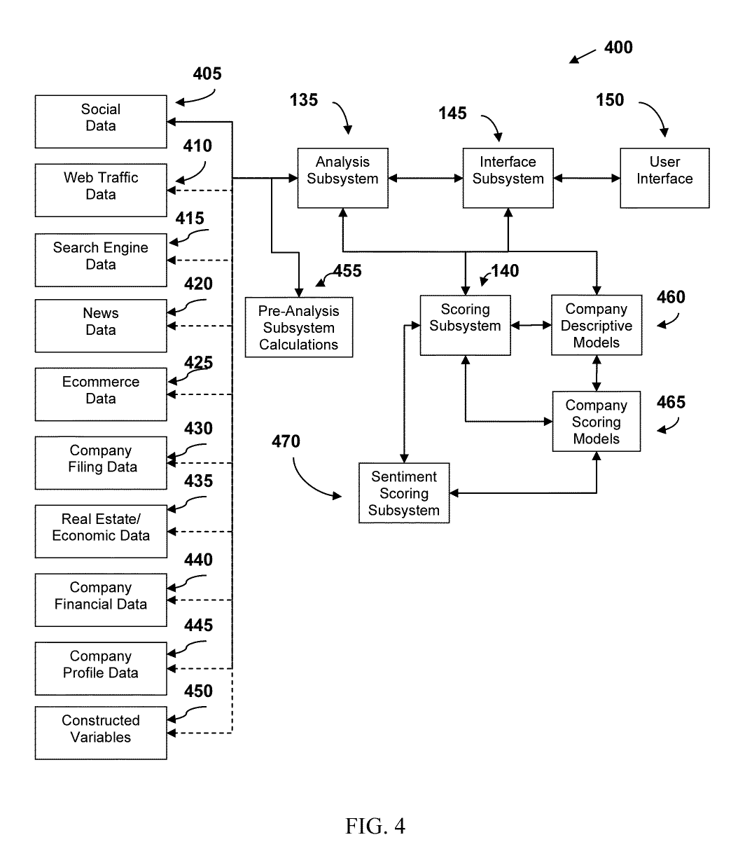

The present invention can have an analysis subsystem and scoring subsystem architecture 400 such as that depicted in FIG. 4. Specifically, the analysis subsystem and scoring subsystem architecture 400 can include the analysis subsystem 135, which can send and/or receive information to/from the interface subsystem 145, which can send and/or receive information to/from the user interface 150. One or more of social data 405, web traffic data 410, search engine data 415, news data 420, ecommerce data 425, company filing data 430, real estate/economic data 435, company financial data 440, company profile data and constructed variables 450 can be sent and/or received to/from the analysis subsystem 135. The transfer of information between the analysis subsystem 135 and one or more of the data sources 405 to 450, inclusive, can be subject to pre-analysis subsystem calculations 455. Also, the analysis subsystem 135 can send and/or receive information to/from the scoring subsystem 140. Further, the interface subsystem 145 can send and/or receive information to/from the scoring subsystem 140. Information from the analysis subsystem 135, the interface subsystem 145 and/or the scoring subsystem 140 can be used to generate or modify company descriptive models 460. Conversely, information from the company descriptive models 460 can be sent to the analysis subsystem 135, the interface subsystem 145 and/or the scoring subsystem 140. Information regarding the company descriptive models 460 can be used to generate or modify company scoring models 465. Conversely, information regarding the company scoring models 465 can be used to generate or modify the company descriptive models 460. Information regarding the company scoring models 465 can be sent to the scoring subsystem 140, and information from the scoring subsystem 140 can be used to generate or modify the company scoring models 465. Information from the company scoring models 465 can be sent and/or received to/from a sentiment scoring subsystem 470, which can send and/or receive information to/from the scoring subsystem 140.

Company Descriptive Model Subsystem

The present invention maintains and utilizes analytical descriptions of each company by way of company descriptive models 460.

Through a web based input form, all available data sources are mapped to each company. This information includes, without limitation, relevant product and service search terms, ticker symbols, related website URL's, Facebook ID's, product name, product codes, and sales locations, the names of company leaders, Twitter account names held by these company leaders, geographic footprint information, and the like. Similarly, this information is captured for major competitors of each company.

Analysis Subsystem

The analysis subsystem 135 performs calculations based on user inputs. These inputs include the company being looked at and the metrics requested.

A key component of the analysis subsystem 135 is the company scoring model 465, which is part of the scoring subsystem 140. The company scoring model 465 defines the data inputs and transformations.

A score for each company is derived based on a scoring model that is created for that company. The scoring model describes the inputs and weights to be used for each company score.

The company descriptive model 460 describes factors that are relevant to the company, as described earlier, such as relevant social media search terms. The company scoring model 465 describes the factors that the present invention has determined to be relevant for the purpose of calculating a score. The sentiment subsystem 130 is part of the process of performing the calculations involved in the process.

For example, the Company Descriptive Models 460 may say that “ipad” is a relevant Twitter search term for Apple Company. The Company Scoring Model 465 may then say that the volume of discussion about “ipad” (that is, the number of times it is mentioned) should have a weight of X and the sentiment of the discussion should have a weight of Y in the scoring model. These would then either be retrieved directly from the database or would be calculated based on direct inputs from the database.

The present invention can calculate a set of scores for each company in the following manner:

Step 1: The first step in the creation of a score is to develop a model for each company. The administrator constructs the Company Descriptive Model 460 as described earlier. Likely data inputs are created based on what is entered into the Company Descriptive Model 460.

Step 2: As data is populated into these fields, the present invention creates a list of available factors. These factors include the following: 1. Volume and count data for each numeric input. An example of this is Facebook “likes.” 2. Sentiment scores for text based data, as calculated by the present invention. This includes average sentiment as well as ratios such as total positive comments divided by total negative comments, total negative comments divided by total comments, and total positive comments less total negative comments divided by the total. These models also include sentiment scoring parameters derived for each company and topic. 3. Rates of change. 4. Volume, counts, sentiment, and rates of change relative to the company's competitors. 5. Intermediate computed factors such as seasonality. In the case where there are multiple inputs for the same source, for example Facebook profiles, these can be entered individually or as a total.

See Table 3: Sample Scoring Model Variables From Company Descriptive Model 460 for a list of sample variables.

Step 3: Data is normalized and filled as necessary using standard statistical techniques.

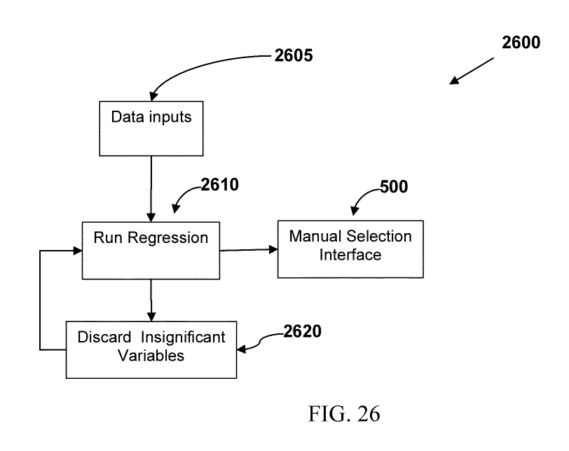

Step 4: The present invention then calculates best fit using simple least squares regression modeling for each company and its related stock, as illustrated in FIG. 26. The initial calculation can be done using an automatic, iterative, least squares approach, whereby a list of available inputs is provided to the model. All available variables, including those variables with basic transformations (such as *−1 and inverted) are also included. After this first step, parameters with a negligible influence are discarded from the model and the more parsimonious model is estimated by using the numerical algorithm again. This backwards stepwise process is iterated until no more parameters can be discarded. This analysis is fitted against Statistical methodologies that are applied using normal industry and scientific practices. The present invention can also be readily adapted to use other regression based approaches, and is not dependent upon one particular regression or presentation approach.

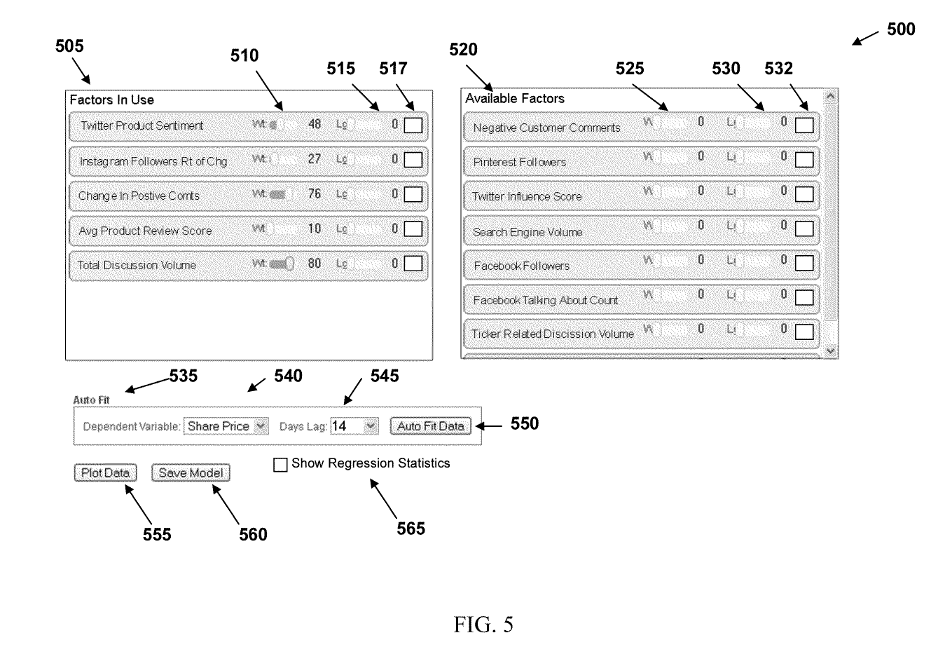

Step 5: Via an interactive screen as illustrated in FIG. 5: Sample Factors and Manual Weighing Interface, the administrator can modify the inclusions and weightings of relevant factors through an iterative process. Factors can also be lag adjusted. New factors can be added. This is done via a drag-and-drop process. Manually adjusted weightings and lags are implemented via slider bars. Transformations can be done using input boxes 517 and 532. The user can than visually plot the data to fine tune results. The administrator can also periodically modify and update model weightings as stock prices, Company Descriptive Model 460 parameters, and market conditions evolve.

The present invention can have Sample Factors and Manual Weighing Interface 500 such as that depicted in FIG. 5. Using the Interface 500, factors can be dragged and dropped from one box to the other and weightings can be adjusted via slider bars within each box. Specifically, the Interface 500 can include a “Factors In Use” field 505, an “Available Factors” field 520, an “Auto Fit” field 535, a “Plot Data” button 555 and a “Save Model” button 560. The “Factors In Use” field 505 can include a series of factors, each having a slider bar for weight 510 and a slider bar for lag 515. Simple transformations, such as “*−1” can be added in 517. The “Available Factors” field 520 can include a series of factors, each having a slider bar for weight 525 and a slider bar for lag 530. Simple transformations, such as “*−1” can be added in 517. Simple transformations include “*” for multiply and “̂” for raise to the power of the number that follows. The “Auto Fit” field 535 can include a drop-box for selecting a “Dependent Variable” such as “Share Price” 540, a drop-box for selecting “Days Lag” 545, which, in this example, is “14” and an “Auto Fit Data” button 550. The fields 505 and 520 can include a vertical slide bar. In this case, only the field 520 has such vertical slide bar (right side of FIG. 5). The field 565 allows the user to view standard regression statistics showing factors such as r-squared, individual variable p-statistics, and the like.

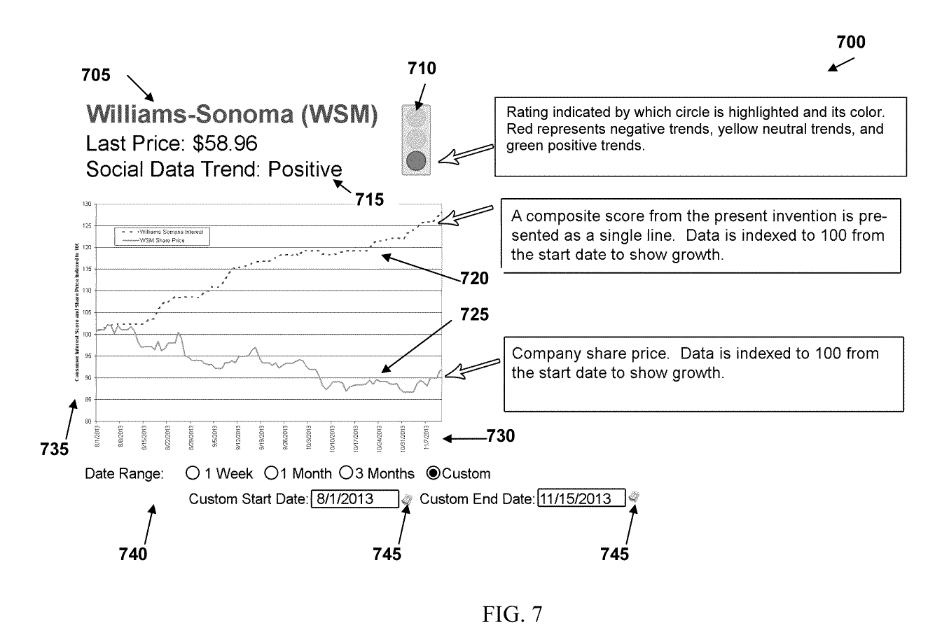

Step 6: An aggregate “interest” score is computed as a time series. This is illustrated, for example in FIG. 7.

Step 7: A simplified score is calculated as described in Front End Scoring Subsection.

TABLE 3
Sample Scoring Model Variables From Company
Descriptive Model 460

| | Company, | Company |
|---|---|---|
| | Product & | Ticker & Stock |
| | Brand | Trading |
| Variable | Related | Related |
| Twitter Phrase Filtered Text Sentiment | X | X |
| Twitter Hashtag Associations | X | X |
| Twitter Phrase Filtered Volume | X | X |
| Facebook “Likes” | X | |
| Facebook “Talking About” Count | X | |
| Instagram “Likes” Rate of Change | | |
| News Articles Text | X | X |
| News Article Sentiment | X | X |
| Blog Text Sentiment | X | |
| Blog Text Volume | X | |
| Product Reviews Text Sentiment | X | |
| Product Reviews Score | X | |
| Site Traffic Change | X | |
| Forums & Discussion Group Text Sentiment | X | X |
| Forums & Discussion Group Volume | X | X |
| Real Estate Prices in Relevant Markets | X | |
| SEC Filing Text - Description | | X |
| SEC Filing Text - Litigation | | X |
| SEC Filing Text - Footnotes | | X |
| Pinterest Postings | X | |
| YouTube Followers and Comments | X | |
| Google Plus+ Posting, Counts and the like | X | |
| Tumblr Postings, Counts, and the like | X | |
| LinkedIn Postings, Counts, and the like | X | |
| Delicious.com Postings and Hashtags | X | |
| Delicious.com Postings and Hashtags | X | |
| Volume | | |
| Company social media influence rating as | | |
| calculated by present invention. | | |
| Historical Quarterly Sales (for seasonality) | | |

Applying Scoring Models

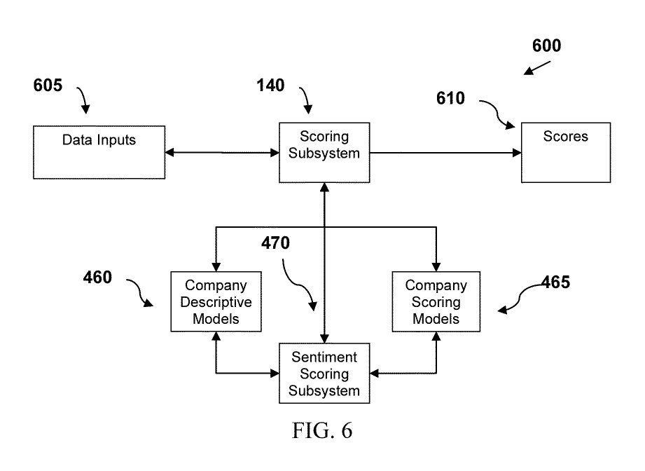

The present invention can have a scoring process after model calculation 600 such as that depicted in FIG. 6. Specifically, the process 600 can include the scoring subsystem 140, which can send/receive information to/from one or more of data inputs 605, the company descriptive models 460, the company scoring models 465 and/or the sentiment scoring subsystem 470. The scoring subsystem 140 can generate scores 610 based on the one or more of the data inputs 605, the company descriptive models 460, the company scoring models 465 and/or the sentiment scoring subsystem 470.

Front End Scoring Subsystem

In addition to providing a wide range of investment insights about each company, the present invention provides several scores for each company. These scores are derived from the computed Interest score as described herein.

These resulting scores are an aggregate measure of the change in sentiment and discussion and social activity volume (“buzz”) as well as other factors. These scores are adjusted in order to be predictive of stock prices and to provide a quick reference to the user as to social-financial trends.

The score is presented in three ways: A social-financial star rating system: 1-5 stars; A social-financial traffic light; A linear graph showing growth in the present inventions composite raw score calculation normalized to a fixed point in time.

TABLE 4
Presentation Format Definitions

| Score | Description |
|---|---|
| Star Rating System | Companies are rated from one to five stars. This rating is assigned |
| | based on the rate of change of the composite score calculated by the |
| | present invention. Companies with no statistically significant change |
| | are scored three Stars. Companies with declines are rated one and two |
| | stars. The present invention is calibrated such that approximately the |
| | bottom third of decliners are rated one star. Similarly, positive |
| | companies are rated four and five stars with approximately the top |
| | third of the companies with positive trends are rated one star. |
| Traffic Light | Similar to the Star Rating System, the present invention incorporates |
| | a social-financial “traffic light.” Companies with a positive trend in |
| | the present invention's score receive a green light. Companies with |
| | no statistically significant change receive a yellow light. Companies |
| | with negative trends receive a red light. |
| Line Plot | For more advanced users, the present invention provides scores as a |
| | line plot trend line, with or without a forecast beyond the present |
| | date. This line is normalized to 100 relative to a start date. This is in |
| | order to provide a comparable benchmark across companies. |

Scores are calculated for three time periods, instant, short-term, and long term as defined in Table 5.

TABLE 5
Score Duration Definitions

| Score | Description |
|---|---|
| Long-Term Score | Reflects conditions over the past 3 months-plus, |
| | depending on user preference and data availability. |
| Short-Term Score | Reflects conditions over the past 3-5 days. |
| Instant Score | Reflects conditions over the past 30 minutes. |

FIG. 7 illustrates the traffic signal indicator with the composite trend line interest score shown below.

The present invention can include a display of a traffic light score with total interest line 700 such as that depicted in FIG. 7. Specifically, the display 700 can include a company information field 705, which can include one or more of a company name, company ticker symbol, last price field and a social data trend field 715. The text in the social data trend field 715 can be “Negative”, “Neutral” or “Positive”. The display 700 can include a traffic light icon 710 in which a trend can be indicated by a highlighted circle and color. For example, red can represent a negative trend, yellow a neutral trend and green a positive trend, which can correspond with the text presented in the social data trend field 715. The display 700 can include a chart with dates along the x-axis 730 and “Consumer Interest Score and Share Price Indexed to 100” along the y-axis 735. In this example, the dashed line 720 represents the “Williams Sonoma Interest” score over time, which can be a composite score presented as a single line wherein data can be indexed from a start date to show positive or negative growth. Also, in this example, the solid line 725 represents the “WSM Share Price” over time, which also can be indexed from a start date to show positive or negative growth. Input 740 allows the user to select a date range or enter a custom date range. 745 presents a drop down calendar that lest the user select a date.

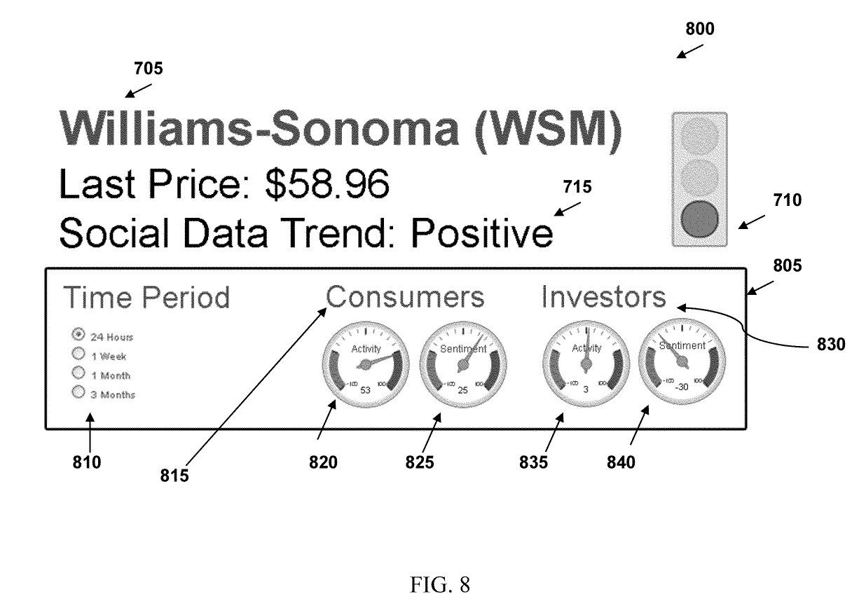

FIG. 8 illustrates the present invention traffic light score with meters showing activity level trends and sentiment around consumers and investors. Activity and sentiment labeled consumers measures the present invention scoring of social data related to the company's products and services and how consumers of these products are behaving on line in relation to them. Activity and sentiment related to Investors measures just discussion and activity levels directly related to the company's stock and stock price.

The present invention can have a display of a traffic light score with activity and sentiment levels of consumers of company products and with investors in the company stock 800 such as that depicted in FIG. 8. Specifically, the display 800 can include the company information field 705, the social data trend field 715 and the traffic light icon 710. Instead of or in addition to the plot described above, the display 800 can include a field 805, which can include a “Time Period” selection field 810, which itself can include user selectable radio buttons for various time periods such as 24 hours, 1 week, 1 month and 3 months as set forth in this example. The display 800 can include a consumer information field 815 and an investor information field 830. Each of the fields 815 and 830 can include an activity gauge 820, 835 and a sentiment gauge 825, 840. Each of the gauges 820, 825, 835, 840 can have a scale from −100 to +100 with 0 at the vertical point of the gauge. Each of the gauges 820, 825, 835, 840 can have a needle pointing to a reading of the particular gauge for the selected time period and can include a numeric display of the reading in the lower portion of each gauge. When a user clicks between the various available time periods, the needles on the gauges can be animated to show a positive or negative change between the previously selected and currently selected time period, and the information presented in the company information field 705, the social data trend field 715 and the traffic light icon 710 can change accordingly.

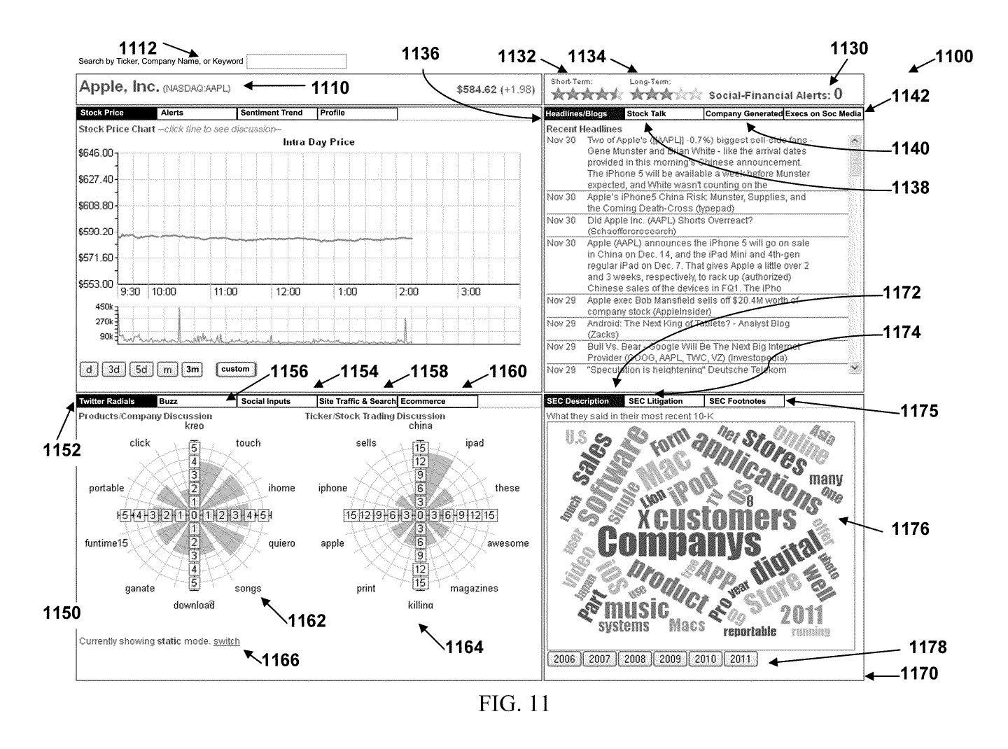

FIG. 11 illustrates the present invention's star rating system.

The present invention can also filter and rank companies based on likely investment potential based on the incorporation of the scores in conjunction with other data including share price trend, pending events such as earnings release dates, and previous earnings surprise history. For example, companies with rising social interest as calculated by the present invention or high scores as calculated by the present invention can be filtered to show the user only such companies with falling share prices and pending earnings release dates in within a specific time window.

Interface Subsystem

The interface subsystem 145 provides the layer that interacts with the user interface 150 and the back end. As per normal industry “model view controller” (MVC) web development practices, the layer performs much of the calculations necessary to create the user interface 150.

User Interface

The user interface 150 is a web based application that allows the user to navigate the features of the present invention in a graphical and interactive manner.

The present invention can have a user interface workflow 900 such as that depicted in FIG. 9, which relates to the user interface 150. Specifically, the workflow 900 can include a user login step 905. After logging in, the user can be presented with one or more of the following interfaces: a company screening interface 910, a direct analysis features interface 915 and/or a portfolio interface 920. Also, if the system detects, for example, the absence of the user from interacting with the workflow 900 for a prescribed amount of time, the user can be returned to the user login step 905. The company screening interface 910 can send and/or receive information to/from a company detail and analysis page 975, which itself can send and/or receive information to/from one or more of the following subsystems: scores 980, social data 982, alerts 984, stock price 986, SEC filing text 988, news 990, sentiment trends 992, company profile 994 and/or other 996. The stock price subsystem 986 can send and/or receive information to/from one or more of a stock price relative to sentiment and buzz subsystem 998 and/or a stock price relative to scores subsystem 999. The direct analysis features 915 can send and/or receive information to/from one or more of the following subsystems: social media monitoring 945, ecommerce analysis 950, social media monitoring and analysis 955, real estate analysis 960, site traffic analysis 965 and/or other 970. Information flowing between direct analysis features interface 915 and one or more of the subsystems 945 to 970, inclusive, can be subject to a sentiment analysis subsystem 935 and/or a geo-social analysis subsystem 940. The portfolio interface 920 can send and/or receive information to/from one or more of a specify investment portfolio subsystem 925 and/or a set desired alerts subsystem 930.

All web-based user interfaces in the present invention can be implemented using PHP programming language, in conjunction with HTML and JavaScript.

Company Screening Interface

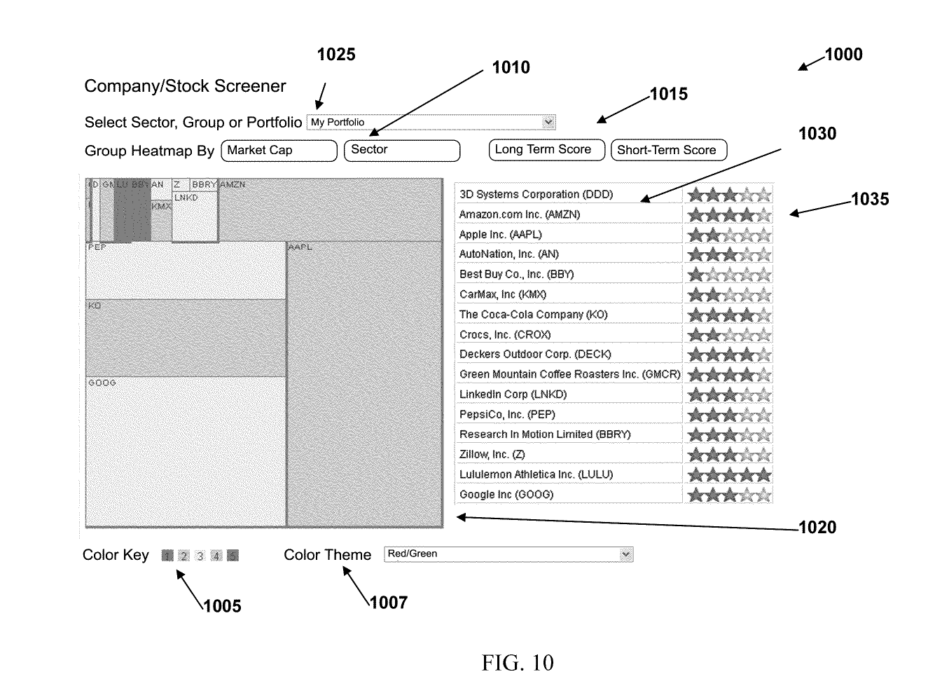

The present invention can display the universe of listed stocks by market capitalization and by the score it calculates for each company in the company screening interface 910. This allows users to quickly assess which stocks are of interest. This is illustrated in FIG. 10.

The user can view this chart in one of several ways:

All stocks sized by market capitalization and grouped by sector.

All stocks equally sized and grouped by sector.

Sector-specific stocks sized by market cap and grouped by subsector.

Sector specific stocks grouped by subsector, equally sized.

Users can easily screen stocks. First, the stocks are color coded according to the present invention's scores which factor social data sentiment and so on as described elsewhere in this document. The user then selects filters (not shown).

To access the company of interest, the user can either click on the company's box on the graphical interface or search for the company by ticker. An example of one of these boxes is indicated by the arrow labeled 1 in FIG. 10.

The company screening interface 910 of the present invention can be, for example, a stock screening graphical interface 1000 such as that depicted in FIG. 10. Specifically, the interface 1000 can display ticker symbols for a plurality of companies in boxes that are sized according to a particular attribute of the company, such as market capitalization or some other attribute, and can be grouped, for example, by market sector. Each company's box can be color coded according to a score, which can be, for example, the score 610 generated by the scoring subsystem 140 or a variant thereof. In this example, a color key 1005 for the score is displayed near the top of the interface 1000, and the scores range from 1 to 5, inclusive. Each number from 1 to 5 inclusive has a color associated with the score and scores in between the two scores can be blended as appropriate. The interface 1007 allows the user to change the color theme. Options include red/green and blue/yellow. The interface 1000 can also include a first selection field 1010 for switching between two views. In this case, the first selection field 1010 can be used to flip between a first display according to market capitalization and a second display according to sector view. The interface 1000 can also include a second selection field 1015 for switching between two views. In this case, the second selection field 1015 can be used to flip between a first display according to long-term score and a second display according to short-term score. A user can use a pointing device such as a mouse to select one of the companies as exemplified by arrow 1020, which can result in a display of additional information about the selected company, detailed herein. Interface 1025 allows the user to narrow the view. The user can select specific sectors according the common industry sector definitions, common indices such as the S&P 500 or Russell 3000, or user-entered portfolios.

Company/Stock Dashboard

An element of the present invention is the Company Dashboard which shows key social financial information for publicly traded stocks. For each company traded on major exchanges users can access a dashboard. The dashboard provides social-financial trends, on screen alerts, and a short-term and long-term proprietary score. (Optionally, the user can add an instant score.) See Table 5 for definitions of the time spans of these scores.

The purpose of this page is to provide risk alerts and tools to identify the relative investment opportunity provided by the company. It also serves to present the company specific information collected by the present invention. Further, it provides a snapshot of current social factors that affect the company and trends in these factors.

The present invention can have a company/stock specific analysis dashboard 1100 such as that depicted in FIG. 11. Specifically, the dashboard 1100 can include a company name and share price field 1110. In this example, the field 1110 includes information regarding a particular company, “Apple, Inc.” in this example, the name of the exchange, “NASDAQ”, the ticker symbol, “AAPL”, the current trading price, “$584.62”, the daily change in trading price, “+1.98”, and tabs for switching between various fields including “Stock Price”, “Alerts” (which can include an indicator of the number of alerts, in this case “0”), “Sentiment Trend” and “Profile”. In the illustrated example, “Stock Price” is selected, which displays a “Stock Price Chart”, which displays the “Intra Day Price” for the given company. The x-axis provides the time of day, the y-axis provides the share price, and a line plots the change in share price over time. Underneath the “Stock Price Chart” is a corresponding volume chart showing the number of shares traded on the y-axis. Near the bottom of the field 1110, a user can select different time periods for the x-axis of the “Stock Price Chart”, in this case, 1 day (“d”), 3 days (“3d”), 5 days (“5d”) and 1 month (“m”), 3 months (“3 m”), and custom. “Custom” allows the user to specify a date range. In this example, the 1 day view is selected. A user can click on the “Stock Price Chart” to generate a display of information pertinent to that company at that moment in time. The present invention can have input 1112, which is a dynamic type-to search feature. As the user types, with each keystroke, the field contents are searched in the database and a popup box shows available companies. This, as with other dynamic display features can be implemented using JavaScript AJAX calls.

The dashboard 1100 can include a company score field 1130. The field 1130 can include a short-term star rating 1132, a long-term star rating 1134, a “Social-Financial Alerts” field (which can include an indicator of the number of alerts, in this case “0”), a “Headlines/Blogs” tab 1136, a “Stock Talk” tab 1138 that shows recent discussion streaming about the stock and its trading, a “Company Generated” tab 1140 that shows social commentary generated by the company itself, and an “Execs on Twitter” tab 1142. In this case, the “Headlines/Blogs” tab 1136 is selected, which displays in the field below “Recent Headlines” and a time-sequential listing of information about the subject company. In this example, the date is shown along the left side of the field 1130 and a vertical slider is provided on the right side of the field 1130. If the “Stock Talk” tab 1138 or the “Execs on Social Media” tab 1142 is selected by the user, then recent tweets and social media discussion regarding the subject company's stock or tweets and other social media postings from executives associated with the company can be displayed, respectively, in field 1130. Similarly, pressing on tab 1140 can show tweets and other discussion generated by the company itself.

The dashboard 1100 can include a model input explorer field 1150. The field 1150 can include a “Twitter Radials” tab 1152, a “Social Inputs” tab 1154, a “Buzz” tab 1156, a “Site Traffic and Search Engine” tab 1158 and an “Ecommerce” tab 1160. Tab 1154 can provide charting of data such as Facebook, Pinterest, YouTube, Google Plus+, and Instagram related data. This data includes followers and comments. In the case of Facebook, this can include “Likes” and “Talking About Count.” Tab 1158 can allow the user to look at related site traffic data and search engine data. In this example, the “Twitter Radials” tab 1152 is selected, which can display information about the company generated from information obtained from Twitter about the company. In this example, the “Twitter Radials” tab 1152 results in the display of a “Products/Company Discussion” text radial 1162 and a “Ticker Stock Trading Discussion” text radial 1164. In this example, the “Products/Company Discussion” text radial 1162 displays ten words associated with the company's products or the company as a whole with a radiating bar representing the frequency of use for the specific term displayed along an axis to indicate the relative frequency of use compared to other terms. The “Ticker Stock Trading Discussion” text radial 1164 is similar to the “Products/Company Discussion” text radial 1162 except that the information displayed on radial 1164 relates to the ticker symbol instead of the company's products or the company as a whole. If a user selects one of the other tabs 1154 to 1160, inclusive, information associated with social data specific inputs (Facebook, Instagram, Pinterest, YouTube and the like), Buzz, Site Traffic, Search Engine data, and Ecommerce are displayed, respectively, in field 1150. The model input explorer field 1150 can be presented in a static mode as shown in FIG. 11 or in a dynamic mode by clicking a selection button 1166 such as the word “switch” in this example. The user can click on the word “switch” to enable dynamic mode. In the dynamic mode, the information displayed on the radials 1162, 1164 changes in real-time.

The dashboard 1100 can include a current discussion explorer field 1170. The field 1170 can include an “SEC Description” tab 1172 and a “SEC Litigation” tab 1174. In this example, the “SEC Description” tab 1172 is selected, which results in the display of the text “What they said in their most recent 10-K” and a subfield 1176 for displaying a cluster of the most common words used in the selected source that are sized according to frequency of use. Near the bottom of the field 1170, buttons corresponding to different reporting years can be selected for quick comparison through time, in this case, any year from “2006” to “2011”, inclusive, can be displayed by clicking on the associated button. If the “SEC Litigation” tab 1174 is selected, information associated with this subject would be displayed in the field 1170. Similarly, the “SEC Footnotes” tab 1175 is selected, the most commonly associated words in the footnotes section of the filing are displayed.

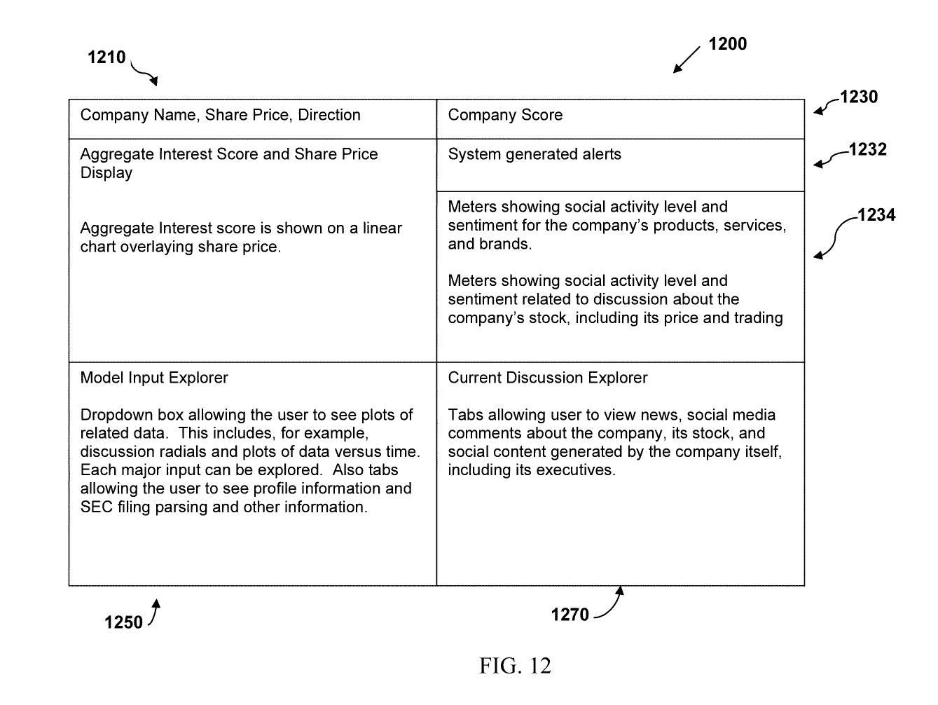

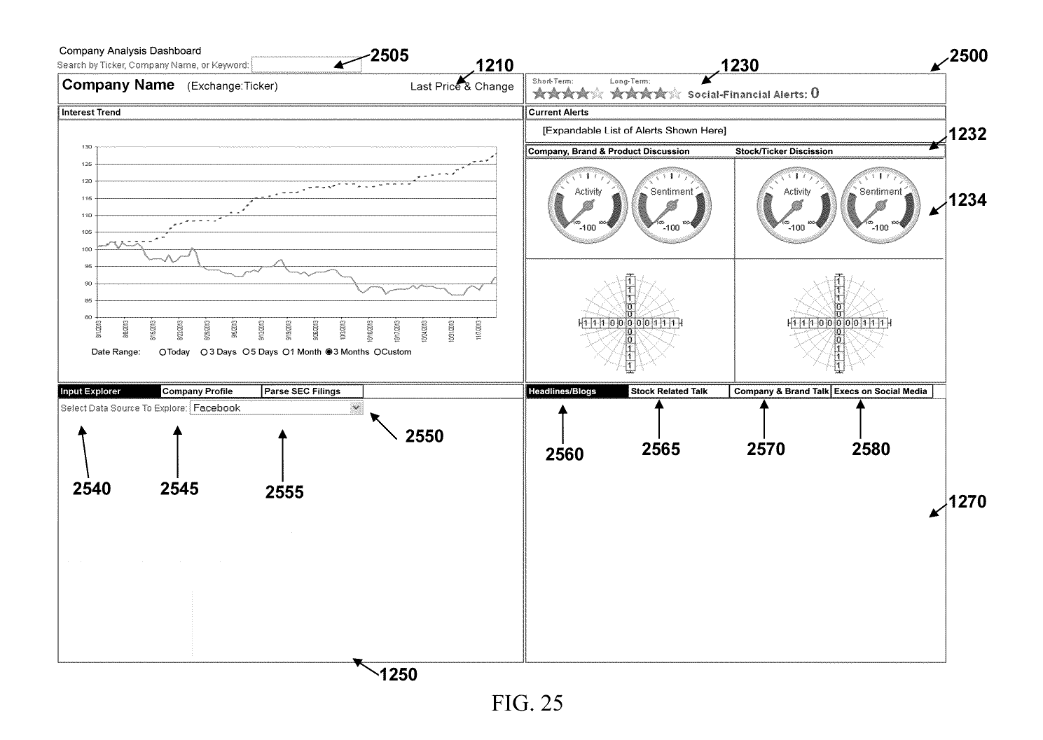

The present invention can have a company/stock dashboard 1200 such as that depicted in FIG. 12. Specifically, the dashboard 1200 can have one or more of a company name and share price field 1210, a company score field 1230, a model input explorer field 1250 and/or a current discussion explorer field 1270. The company name and share price field 1210 can display one or more of an aggregate interest score, a share price display and/or a line plot chart showing aggregate interest score overlaid on share price. The company score field 1230 can display one or more of system generated user alerts related to a particular stock 1232 and/or meters 1234. The meters 1234 can display one or more of social activity level and sentiment for the company's products, services and brands and/or social activity level and sentiment related to discussion about the company's stock, including its price and trading. The model input explorer field 1250 can include a drop down box allowing the user to see plots of related data, which can include, for example, discussion radials and plots of data versus time. Each major input can be explored. The current discussion explorer field 1270 can include a drop down box allowing the user to view news, social media comments about the company, and social content generated by the company itself. This dashboard is further described in FIG. 25. Selecting Tabs 2540, 2545, 2550, 2560, 2565, 2570, or 2580 displays the respective information in the box below the tab. In the case of Tab 2540, “Input Explorer” input 2555 allows the user to select among available inputs. This then displays radials or data plots to allow the user to better understand the raw data.

The dashboard displays many useful types of information. The proprietary Score for each company is prominently displayed at the top. The dashboard also includes Twitter discussion, sentiment, and common words relative to both the company's products and its ticker. Company product discussion is based on tracking keywords that we have identified both through a specific analysis of each company and by mining the company's SEC filing description, Facebook page, and product offerings for relevant keywords. Sentiment is calculated using the custom built sentiment scores as created in sentiment subsystem 130.

In addition to Twitter, the dashboard displays Facebook “likes,” “talking about counts” and posts for each of the company's related Facebook pages. The present invention calculates and displays key metrics, such as change in “likes” and change in “talking about counts.” As with other data, the present invention incorporates this as a measure of interest in the company and its products.

Alerts, which indicate changes in the data measured, are highlighted and the user can click on a tab to view the alerts. These alerts may include, but are not limited to, changes in the sentiment of discussion about the company's underlying products; changes in the volume of discussion or interest in the company and its products; changes in the tone or volume of news headlines; a drop or increase in site traffic relative to the present invention's calculated expectations; changes in calculated expectation of litigation risk based on the litigation section of recent SEC filings; and upcoming earnings releases or other notable or material events.

The content of this page further includes news and blog headlines and content.

A stock price chart serves as a reference, but also allows the user to click anywhere on the chart to see what current discussion and sentiment was going on before a stock price movement.

Sentiment and buzz (here a measure of discussion activity about the company's products) and the score (described elsewhere and incorporating these factors) can be plotted relative to stock price and other displayed factors. These can also be viewed independently.

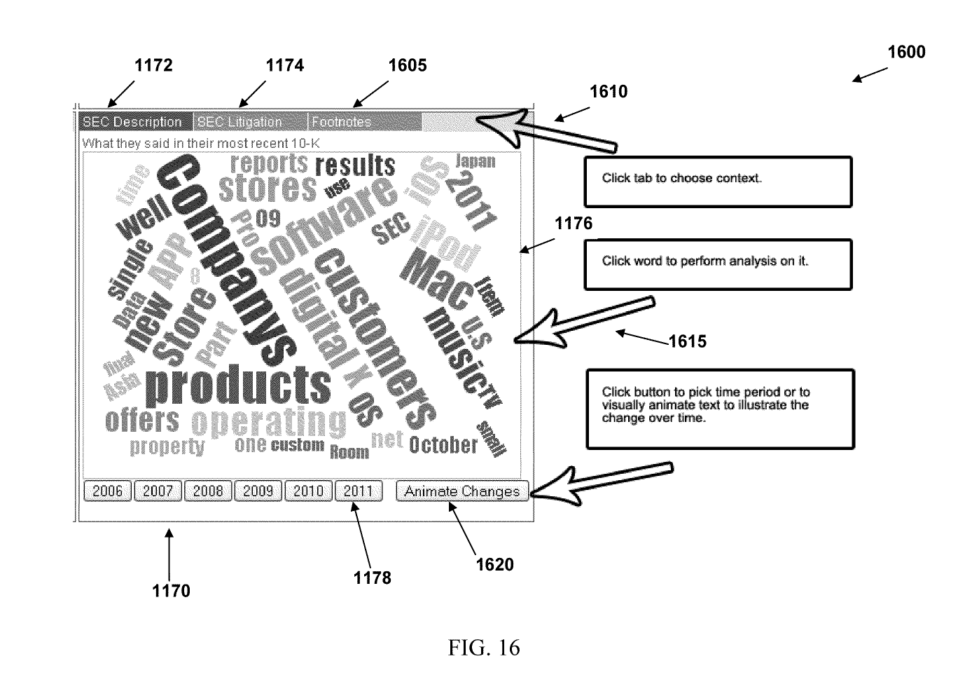

SEC filing text is presented in as a word cloud. See FIG. 16 and related discussion for more information. This information is obtained from publicly filed company Forms 10-K and 10-Q.

This page also includes factors such as ecommerce trends for the company's products (price trends, reviews trends, and so on), trends in site traffic to the company's websites, and a company profile. The company profile includes the company description, market data such as market capitalization, shares outstanding, and stock beta, the company's next earnings release date, and basic financial information such as revenue and earnings per share.

Throughout the present invention, data is presented in a variety of ways.

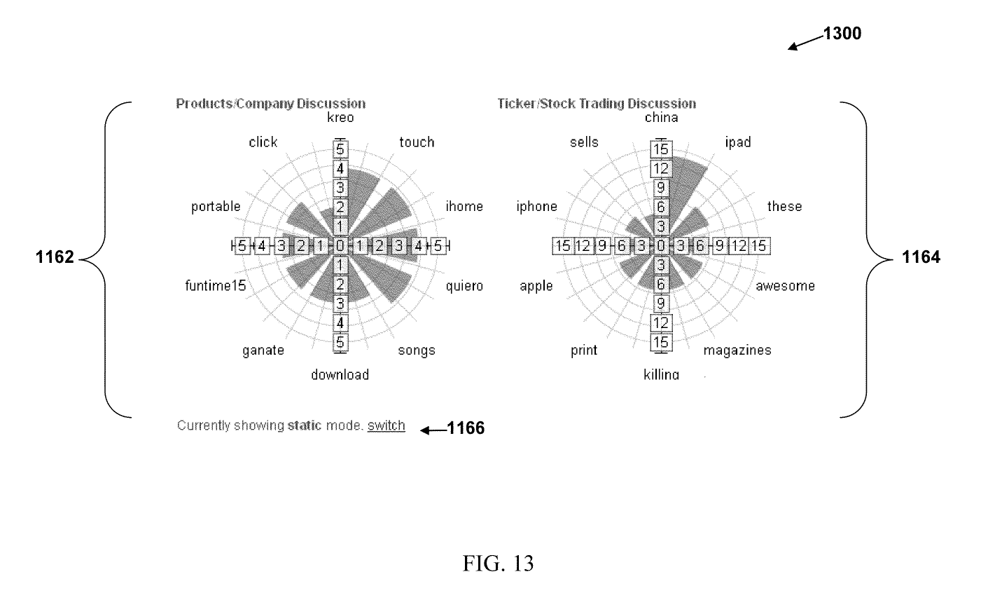

One such way that data is presented is via word radials. Word radials are used to present word usage frequency and to allow the user to obtain more information about those words by clicking on the chart. This is illustrated in FIG. 13.

The present invention can have text radials 1300 to illustrate frequent words such as that depicted in FIG. 13. Specifically, the “Products/Company Discussion” text radial 1162, the “Ticker Stock Trading Discussion” text radial 1164 and the selection button 1166 are illustrated in greater detail in FIG. 13.

From within the above chart, the user can examine each word's usage by clicking on the word. Clicking on the word creates a pop-up box with examples of how the word was used, the context of usage and how that word's usage is associated with sentiment.

The present invention provides this “click to learn more feature” on all charts, including word radials, line and scatter charts, word clouds, and so forth.

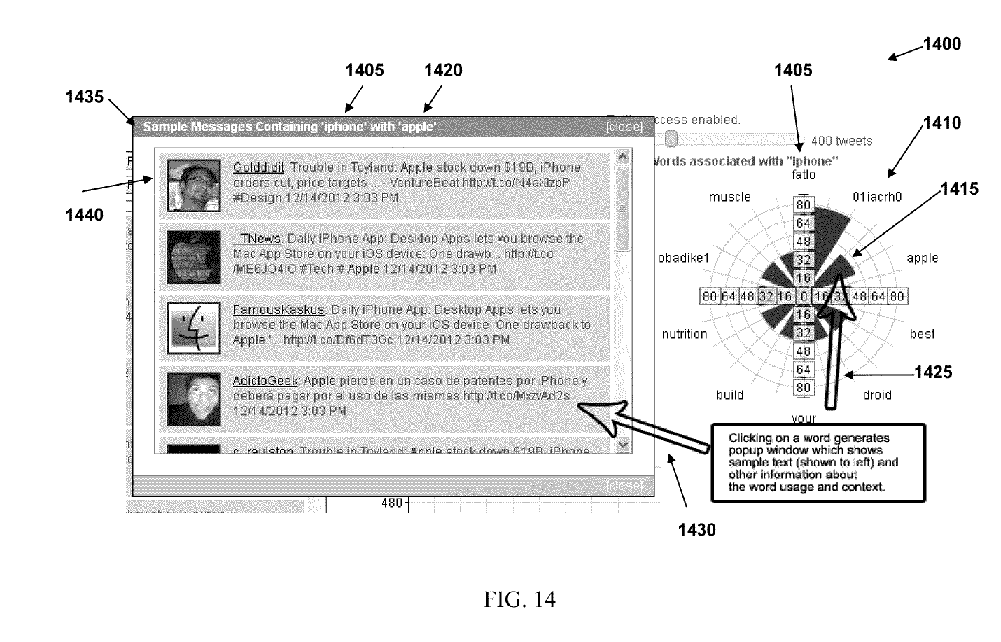

The present invention can have a click to learn more chart feature such as that depicted in FIG. 14. Specifically, a user interface 1400 can include a text radial 1410, which can be similar to the text radials 1162, 1164 described herein. In this example, the text radial 1410 includes a plurality of words 1420 associated with a given term such as “iphone”. Each word 1420 has a radiating bar 1415 representing the frequency of use for the specific term displayed along an axis to indicate the relative frequency of use compared to other terms. When a user clicks on the radiating bar 1415, as represented by arrow 1425, a popup window 1435 can be displayed containing additional information about the selected word relative to the selected company. In the example, a sample message containing “iphone” and “apple” is displayed in window 1435, which can include tweets, icons associated with a particular Twitter user, date and time information or any other desired information.

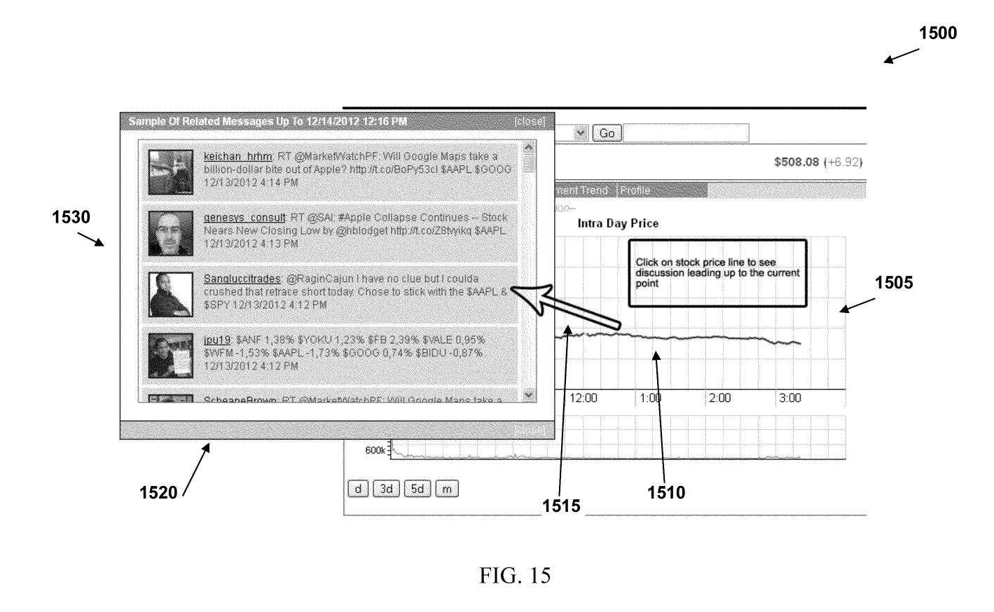

The present invention can have a click on stock price to see discussion leading up to that point in time feature such as that depicted in FIG. 15. Specifically, a user interface 1500 can include a stock chart 1505 with a stock price line 1510. The chart 1505 can be similar or identical to the chart described with reference to FIG. 11 herein. When a user clicks on the stock price line 1510, as represented by arrow 1515, a popup window 1530 can be displayed containing additional information. In the example, related messages relating to the selected company are displayed in window 1530, which can include tweets, icons associated with a particular Twitter user, date and time information or any other desired information. In this specific example, the user clicked on the line 1510 at a time point associated with 12:16 PM, and the window 1530 displays information about the company from 12:16 PM to the current time, which was around 4:14 PM on the day this particular example was captured. The present invention can also present other social content in the same manner, including Facebook postings, LinkedIn postings, blog postings, and the like.

The present invention can also show an input to limit tweets by the influence of the sender. This is based on how many followers the author has. Similarly, sample tweets can be filtered based on followers. Further, the present invention allows filtering based on the sum each time the message has been “retweeted” or rebroadcasted multiplied by the number of followers of each author tweeting or retweeting the message. Similarly, content can also be filtered by sentiment score. This can be set to show only positive or only negative messages, or messages within a certain sentiment score range. This sentiment and influence filtering features can be available within 1400, 1500, 1800, 1900 and elsewhere.

Sec Document Parsing and Incorporation

The present invention also parses key sections of SEC documents. This data is visually presented as a word cloud, or as a radial. The present invention alerts the user when there are material changes in the text of filings from one period to the next.

The present invention incorporates changes in discussion in three key sections of the document:

How the company describes itself

The company's reported litigation discussion.

Footnotes to financial statements.

The present invention can have an enhanced current discussion explorer field 1600 such as that depicted in FIG. 16. The enhanced current discussion explorer field 1600 can be similar to the current discussion explorer field 1170 such as that depicted in FIG. 11. In addition to the features shown in FIG. 11, the field 1600 can also include a footnotes tab 1605 and an “Animate Changes” button 1620. The user can click 1610 on one of the tabs 1172, 1174 and 1605 to switch between the tabs. Also, the user can click 1615 on one of the words in the display to perform an analysis of the word. This analysis can include showing where it is used, the context of its use, and the most commonly associated words to either side of it. Further, the user can click 1620 on the “Animate Changes” button 1620, which can result in the display of an animation showing the change in commonly used words from year to year. Buttons 1178 are automatically presented based on filing availability via the US Securities and Exchange Commission website and master index. Not shown in FIG. 16, 1600 may also have an option to select document type, including Form 10-K and Form 10-Q. System 1600 can also be presented on its own with a company search feature.

By clicking on buttons, the user can change the document being viewed. The user can also create an animation showing the change in commonly used words from year to year.

Word use animation: Users can view an animation to show how words and word usage have changed over time.

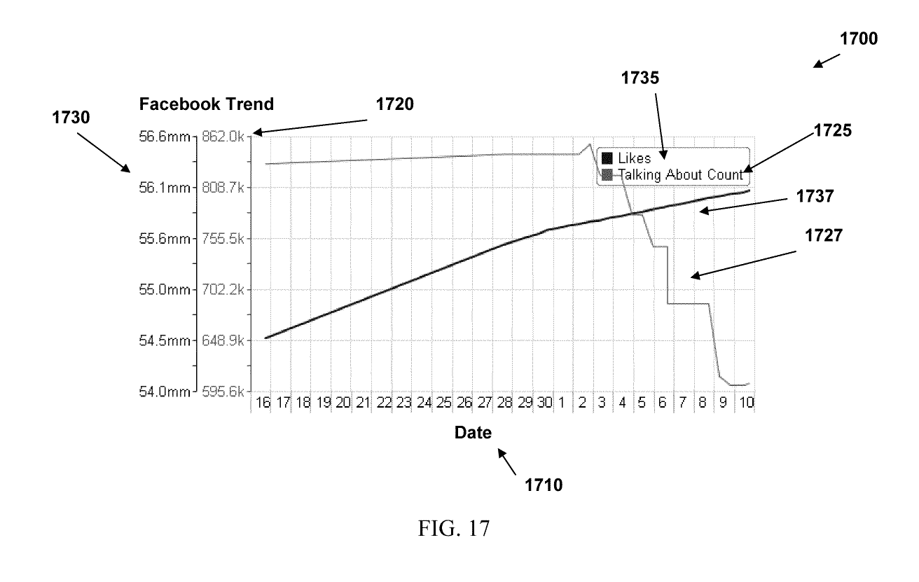

The present invention can have a Facebook trend analysis field 1700 such as that depicted in FIG. 17. Specifically, the field 1700 can include a chart having the date plotted on the x-axis 1710 and two vertical y-axes, a first y-axis scale 1730 for “Likes” and a second y-axis scale 1720 for “Talking About Count”. In this example, the scale 1730 includes 54.0 million to 56.6 million “Likes”, and the scale 1720 includes 595,600 to 862,000 “Talking About Count”. The line 1737 represents the “Likes” through time, and the line 1727 represents the “Talking About Count” through time. The field 1700 can include a legend including a field 1735 for “Likes” and a field 1725 for “Talking About Count”. Not shown in FIG. 17, 1700 can also have an input to select the date range and to switch the data being displayed from actual values as shown in the example, to rates of change or to values indexed to 100. Other social inputs can be similarly displayed including, but not limited to Instagram post counts and followers, Twitter followers, YouTube followers, and the like.

Twitter Monitoring Feature

The present invention allows users to examine and view phrases, tickers, and hashtags being discussed on Twitter through a series of interactive graphics.

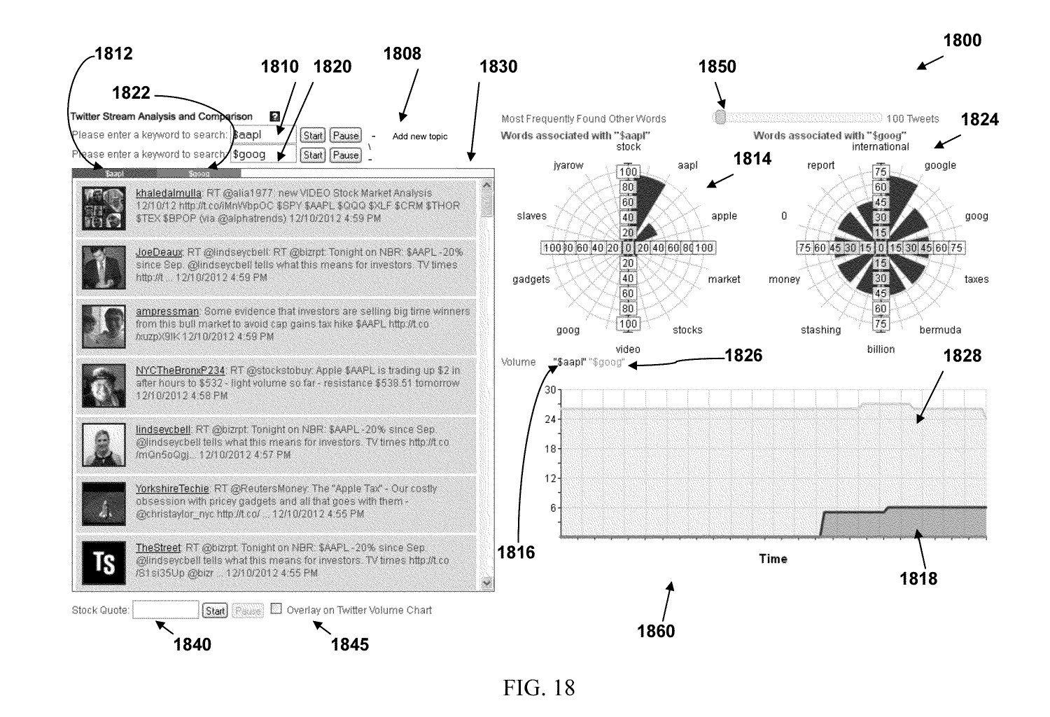

The present invention can have a Twitter stream analysis and comparison system 1800 for comparing multiple Twitter streams such as that depicted in FIG. 18. Specifically, the system 1800 can include a first field 1810 for the user to enter a first keyword or a first search string (“$aapl” in this example) and a second field 1820 for the user to enter a second keyword or a second search string (“$goog” in this example). In this example, “Please enter a keyword to search:” is displayed to the left of each field 1810, 1820 and “Start” and “Pause” buttons are provided to the right of each field 1810, 1820. There is also an option to “Hide Second Topic”. The system 1800 can also have the field set 1808 that allows the user to add new topics by selecting “Add New Topic” to add a Twitter stream or by selecting “−” to remove one. The system 1800 can include a field 1830 for displaying information relating to the search terms entered into fields 1810, 1820. The field 1830 can have a first tab 1812 associated with the first field 1810 and a second tab 1822 associated with the second field 1820. In the example, the first tab 1812 is selected, and the field 1830 displays information regarding “$aapl” from Twitter, which can be similar to that shown in FIGS. 14 and 15. The system 1800 can include display of a first text radial 1814 associated with the first field 1810 and a second text radial 1824 associated with the second field 1820. The radials 1814, 1824 can be similar to those shown in FIGS. 11, 13 and 14. In this example, the radials 1814, 1824 are adapted to show the “Most Frequently Found Other Words” related to the words or strings entered in fields 1810 and 1820, respectively. The system 1800 can include a chart of stock trade volume over time, which itself can include first text 1816 associated with the first field 1810 and second text 1826 associated with the second field 1820, and a first volume plot 1818 associated with the first field 1810 and a second volume plot 1828 associated with the second field 1820. The system 1800 includes a “Stock Quote” field 1840 with “Start” and “Pause” buttons to the right side and a radio box allowing the user to “Overlay on Twitter Volume Chart” 1845. That is, the user can enter a ticker symbol into field 1840 and click on the radio box 1845, which will result in the overlay of a third volume plot (not illustrated) on the chart of stock trade volume over time. Using a horizontal slider bar 1850, the user can select the number of tweets for analysis, in this example, the bar 1850 allows the user to select how far back in terms of tweet count the analysis should go. The user can also specify this in terms of time. In this example, 100 tweets are chosen. The present invention may also have an input to adjust the time scale in 1860, an option to index the data in 1860 to 100 from the start, and an option to add the sentiment score versus time to 1860. The present invention may also have an input field to adjust the number of words or phrases shown in radials 1814 and 1824.

As illustrated in FIG. 18, users can compare one or more Twitter streams. Frequency (upper-right side) and volume (lower-right side) are presented side-by-side. Text from each stream is accessed by clicking on the related tab in the Tweet information box. The user can adjust how far back the analysis should go by using the slider bar at the top.

The user has the option to overlay a ticker price and sentiment on the chart.

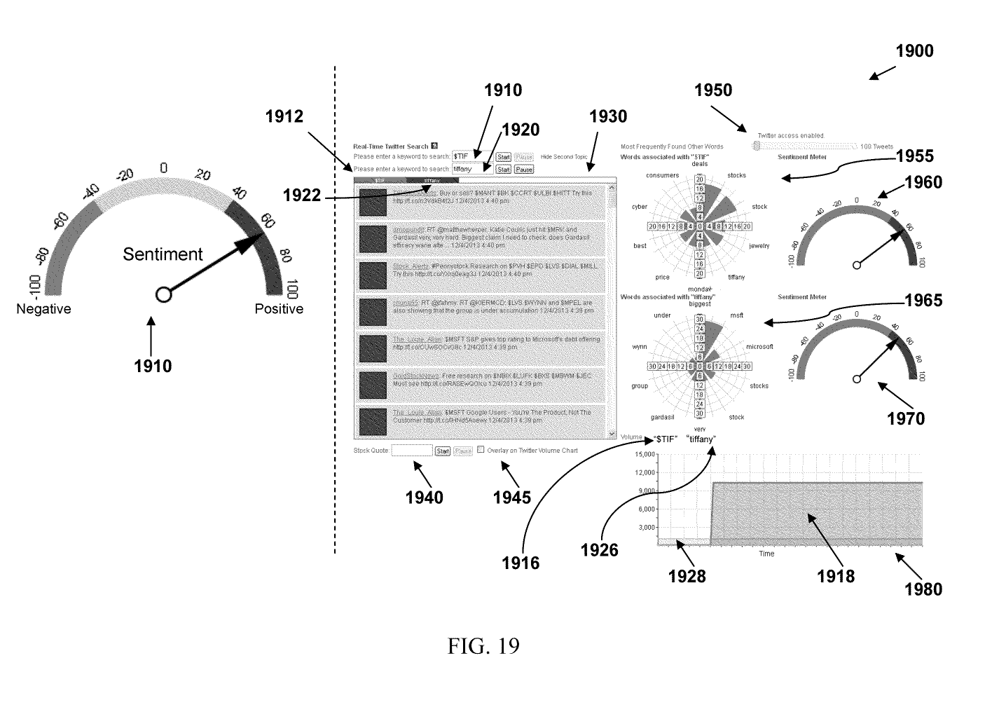

Sentiment can be added as a gauge as illustrated in FIG. 19.

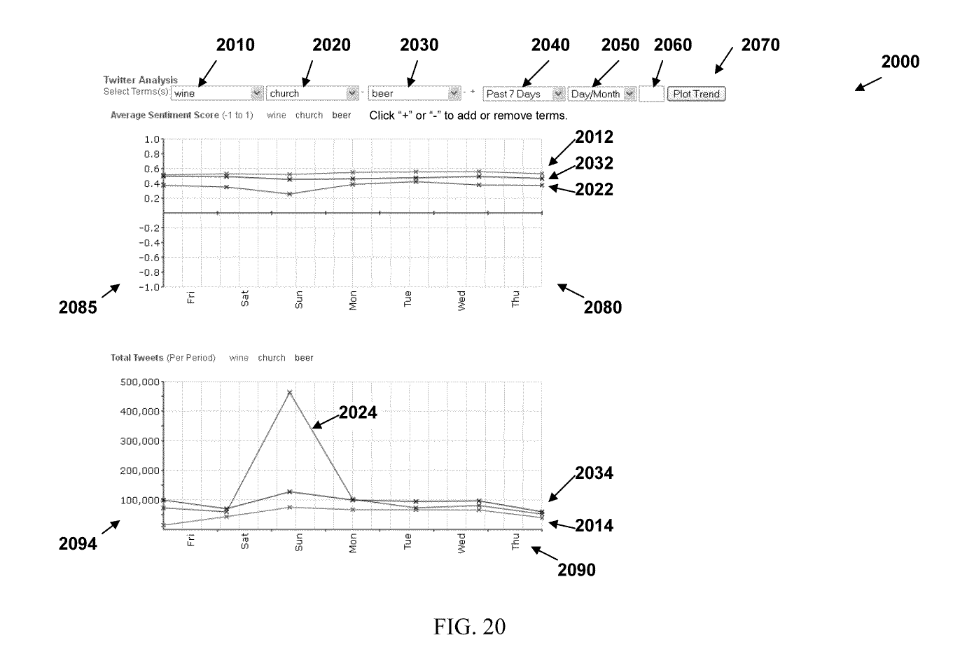

The present invention can have a sentiment gauge system 1900 such as that depicted in FIG. 19. Specifically, the left side of FIG. 19 illustrates an example of a sentiment gauge 1910, which can be similar to those described with reference to FIG. 11. Here, the scale of the sentiment gauge 1910 ranges from −100 to +100 with 0 at the vertical point of the gauge. A sentiment score of about −40 to −100 corresponds with a “Negative” sentiment, a sentiment score of about −40 to about +40 corresponds with a “Neutral” sentiment and a sentiment score of about +40 to +100 corresponds with a “Positive” sentiment. Although −40 and +40 are used as the break points between described categories of sentiment, any suitable number may used for the break point between categories of sentiment. Also, although −100 and +100 are used as the lower and upper limits for the range of sentiment, other suitable numbers can be used, such as −1.0 to +1.0, which is used, for example, in FIG. 20. The “Negative”, “Neutral” and “Positive” sentiments can be similar to those described with reference to FIGS. 7 and 8. The system 1900 can include items 1910, 1912, 1916, 1918, 1920, 1922, 1926, 1928, 1930, 1940, 1945 and 1950, which can correspond with items 1810, 1812, 1816, 1818, 1820, 1822, 1826, 1828, 1830, 1840, 1845 and 1850, respectively, which are described in detail herein. Text radials 1955 and 1965 can correspond with text radials 1814 and 1824, respectively, which are described in detail herein. In addition or in lieu of text radials 1955 and 1965, the system 1900 can include sentiment gauges 1960 and 1970 associated with first and second fields 1910 and 1920, respectively. Not shown in 1900, the present invention may also have an input field to select additional Twitter streams, an input to adjust the time scale in 1980, an option to index the data in 1980 to 100 from the start, and an option to add the sentiment score versus time to 1980.

As with other displays, the user can click on words or Tweets to see examples of word usage and similar Tweets or discussion utilizing the chosen word or words.

FIG. 20 illustrates the comparison of sentiment score to volume over time. The user can select multiple topics to compare and aggregate over time. As with other charts, clicking anywhere on the timeline brings up as sample of discussion and other statistics from the relevant time period.

The present invention can have a system 2000 for comparing discussion of volume and sentiment for specific topics such as that depicted in FIG. 20. Specifically, the system 2000 can include a plurality of drop down boxes for selecting search terms. For example, there can be three drop down boxes 2010, 2020 and 2030 and the terms “wine”, “church” and “beer” are selected from the boxes 2010, 2020 and 2030, respectively. The system 2000 can include a fourth drop down box 2040, which allows the user to select a time period for comparison. For example, a time range such as “Past 7 Days” can be selected from box 2040. The system 2000 can include a fifth drop down box 2050, which allows the user to select the time period for the aggregation of data. For example, a time period such as “Day/Month” can be selected from box 2050, which results in the aggregation of data for each day in the resulting plots. The system 2000 can include a field 2060 for numeric input. The system 2000 can include a “Plot Trend” button 2070, which can be selected once the previously described selections are made. The system 2000 can include a first chart 2080 of average sentiment score over time and a second chart 2090 of total tweets per time period. Each of the first and second charts 2080 and 2090 can have an x-axis 2080 and 2092 corresponding with the time range selected in box 2040. The first chart 2080 can have a y-axis plotting negative to positive sentiment. Here, a scale of −1.0 to +1.0 is used (as noted above, any suitable scale may be employed). Lines 2012, 2022 and 2032 correspond with plots for each of the terms selected in boxes 2010, 2020 and 2030, respectively. The second chart 2090 can have a y-axis plotting the number of total tweets per period. Here, a scale of 0 to 500,000 is used (any suitable scale may be employed). Lines 2014, 2024 and 2034 correspond with plots for each of the terms selected in boxes 2010, 2020 and 2030, respectively. In this example, a dip in sentiment on Sunday corresponds with a spike in tweets.

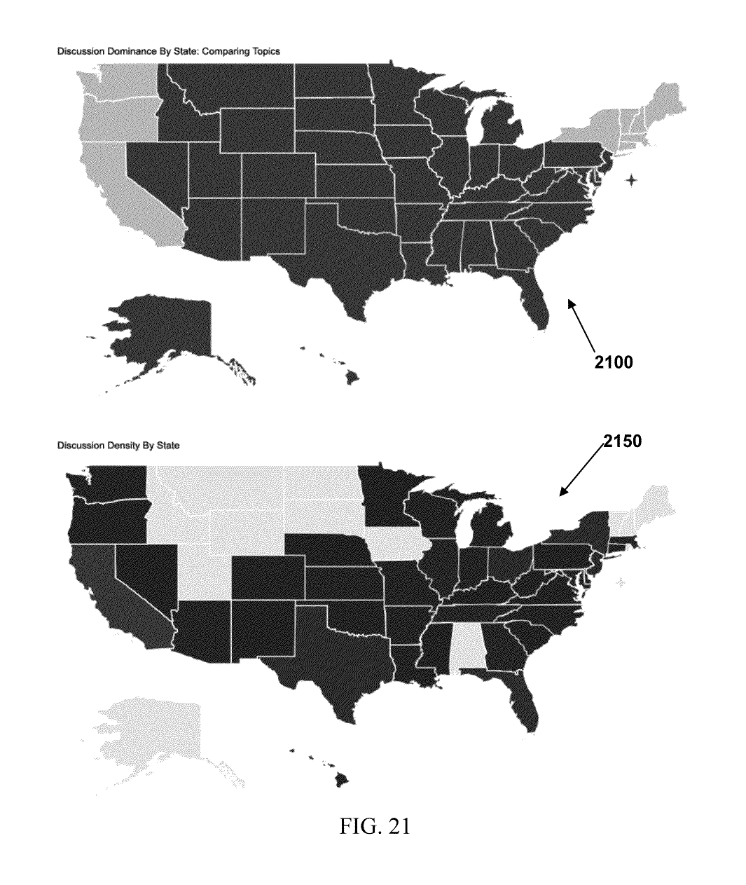

FIG. 21 illustrates discussion and discussion density mapped to location.

The present invention can include discussion mapped to geographic locations to show prevalence of one topic versus another and the density of discussion by location such as that depicted in FIG. 21. Specifically, map 2100 is a geographic plot of discussion dominance by U.S. state when comparing topics. Also, map 2150 is a geographic plot of discussion density by U.S. state.

Real Estate Sales Analysis Feature

The real estate component allows users to analyze each market property by property to understand market trends.

The present invention uses real estate data as a proxy for economic activity. The present invention matches the market footprint of a company to real estate sales as a way to estimate relevant economic health. This is illustrated in FIG. 21. This figure shows mapping to state. The present invention will also map to zip codes.

The present invention also allows users to evaluate a specific market and to compare specific markets. Using drop down menus, slider bars, and roll-over graphics, the user can adjust the analysis inputs. Users can screen results by a variety of parameters. The system calculates market statistics and rate of change using a least squares regression methodology. From the chart, users can click on specific properties to determine property details.

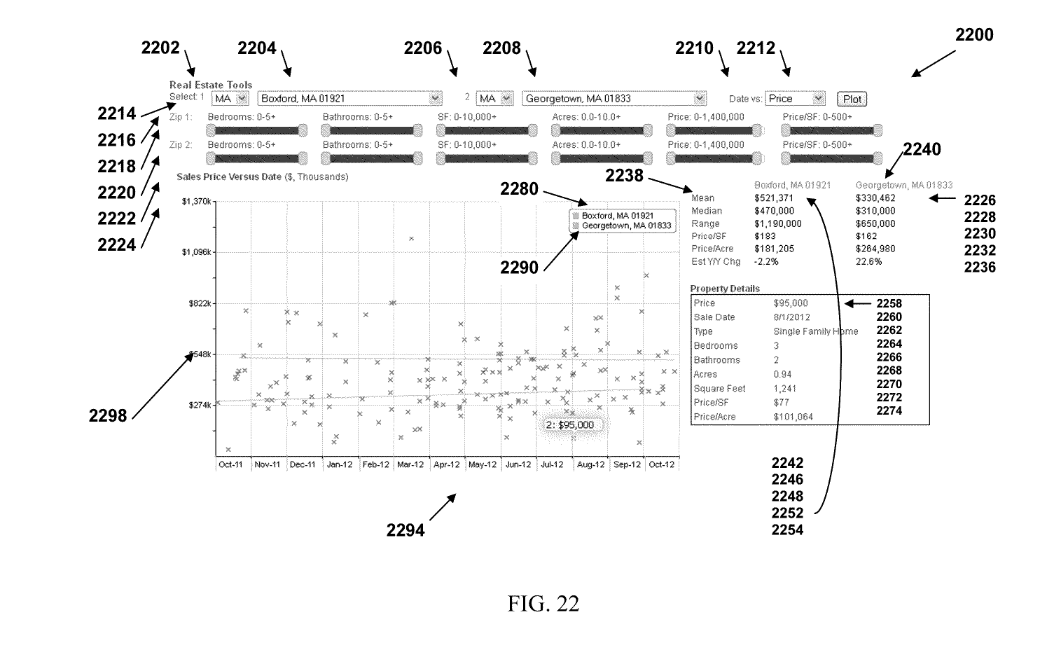

The present invention can have a real estate analysis options system 2200 such as that depicted in FIG. 22. Specifically, the system 2200 can include a first drop down box 2202 for selecting a first particular state (here, two letter codes such as “MA” for Massachusetts are used, for example), a second drop down box 2204 for selecting a particular city/state/ZIP code combination within the first particular state selected in box 2202, a third drop down box 2206 for selecting a second particular state (here, “MA” is selected again), a fourth drop down box 2208 for selecting a particular city/state/ZIP code combination within the second particular state selected in box 2206, a fifth drop down box 2210 for selecting a parameter such as “Price” which is selected in this example, a “Plot” button 2212 and a plurality of sliding bars 2214-2236, inclusive, for selecting various parameters. Specifically, plurality of sliding bars 2214-2236 can include, for example, for the first geographic area selected in boxes 2202 and 2204, a first sliding bar 2214 for selecting the number of bedrooms (for example, “0-5+” can be provided), a second sliding bar 2216 for selecting the number of bathrooms (for example, “0-5+” can be provided), a third sliding bar 2218 for selecting the interior square footage (for example, “0-10,000+” can be provided), a fourth sliding bar 2220 for selecting the number of acres of the land (for example, “0.0-10.0+” can be provided), a fifth sliding bar 2222 for selecting the price of the property (for example, “0-1,400,000+” can be provided) and a fifth sliding bar 2224 for selecting the ratio of price to square footage (for example, “0-500+” can be provided). For the second geographic area selected in boxes 2206 and 2208, sliding bars 2226-2236 can correspond with sliding bars 2214-2224, respectively. The system 2200 can include a chart of sales price versus date based on the previously selections, where the chart plots time on the x-axis 2294 and sales price on the y-axis 2298. Trendlines may be included in the chart. In this example, the pricing trendline is slightly negative for Boxford, Mass. 01921 and slightly positive for Georgetown, Mass. 01833. The chart can include a legend with fields 2280 and 2290 corresponding with the geographic areas selected in boxes 2202-2208. The system 2200 can include a display of mean 2242, median 2246, range 2248, price per square foot (“Price/SF”) 2250, price per acre 2252 and estimated year-over-year change (“Est Y/Y Chg”) 2254 for the first and second geographic areas 2238 and 2240, which correspond with the geographic areas selected in boxes 2202-2208. If the user selects a particular data point on the chart (here, “2: $95,000” indicates the selected data point), property details can be displayed in a field 2256, which can include price 2258, sale date 2260, type 2262, number of bedrooms 2264, number of bathrooms 2266, acres 2268, square feet 2270, price per square foot (“Price/SF”) 2272 and price per acre 2274. The system 2200 allows a user to quickly visualize pricing trends over time for the selected combinations of attributes of a particular economic activity, which is real estate sales in this example. Not show in 2200, the present invention may also have a date range select input field set and an input option to show data indexed to 100 at the start, an input to add further locations, and a input to combine multiple locations into groupings.

Site Traffic Feature

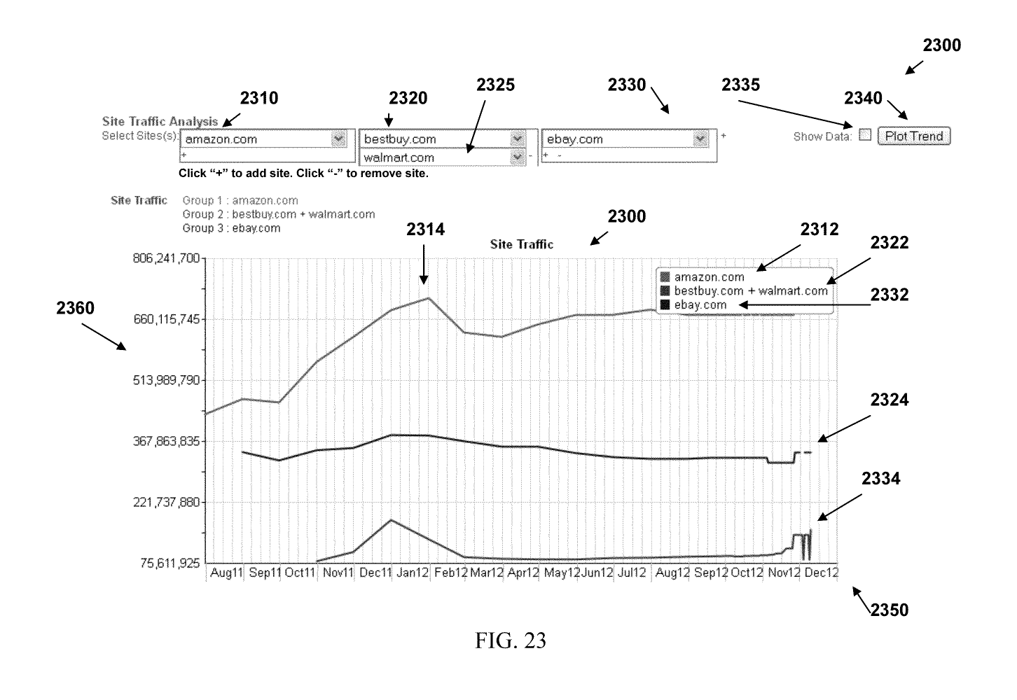

The present invention tracks and monitors website traffic for publicly traded companies with websites. The user can explore site traffic independently, as illustrated in FIG. 23.

The present invention can have a system 2300 for comparing company site traffic to that of its competitors such as that depicted in FIG. 23. Specifically, system 2300, can have a first drop down box 2310 for selecting a first company (“amazon.com” in this example). The box 2310 includes an option (“+”) for adding an additional company to form a composite of two companies under one data set, which is applicable to the second drop down box 2320. In the second drop down box 2320, in this example, a second company is selected (“bestbuy.com” in this example). Also, in this case, after the option (“+”) was selected, a third drop down box 2325 can be provided in the same general area as the second drop down box 2320 for selection of a third company (“walmart.com” in this example). As such, data from the second and third companies will be aggregated in the resulting plot. The system 2300 can include a fourth drop down box 2330 for selecting a fourth company (“ebay.com” in this example). Any suitable number of drop down boxes may be provided and aggregation of data, such as is exemplified by boxes 2320 and 2325 in this example, is not required. Plus and minus symbols (“+−”) can be selected to add or delete boxes, respectively, or groups of boxes, as desired. The system 2300 can include a “Show Data” radio box 2335, which toggles on and off the display of specific data associated with the plot (here, the box 2335 is not selected so additional data is not shown in the chart) and a “Plot Trend” button 2340, which can be used to initiate the generation of the resulting chart. The system 2300 can include a chart of site traffic over time for the selected groups. In the example, Group 1 corresponds with the selection made in box 2310 (“amazon.com”), Group 2 corresponds with boxes 2320 and 2325 (“bestbuy.com+walmart.com”), and Group 3 corresponds with box 2330 (“ebay.com”). The chart can include an x-axis 2350 for date and a y-axis 2360 for site traffic. Lines 2314, 2334 and 2324 can correspond with site traffic for Groups 1, 2 and 3, respectively. The chart can include a legend with suitable information fields 2312, 2322 and 2332 corresponding with each of Groups 1, 2 and 3, respectively. Not show in 2300, the present invention may also have a date range select input field set and an input option to show data indexed to 100 at the start.

Ecommerce Analysis

The present invention monitors ecommerce sites for companies with product sold via online channels. The present invention monitors factors, without limitation, including: price at leading online outlets for important company products, product reviews for product reviews (scores and text) for major company products, and availability of these products at major online outlets

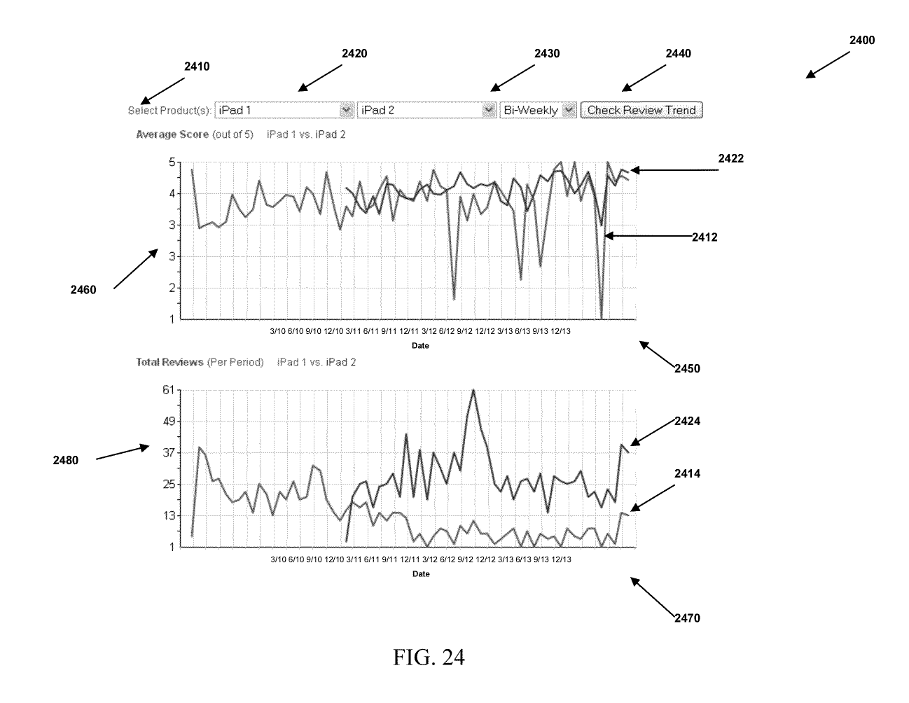

FIG. 24 illustrates the comparison of two products. The user can view and compare products, click on the line for samples of discussions, pricing, and so on for that time.

The present invention can have an online product review trend system 2400 such as that depicted in FIG. 24. Specifically, system 2400 can have a first drop down box 2410 for selecting a first product name (here, “iPad 1” is selected), a second drop down box 2420 for selecting a second product name (here, “iPad 2” is selected), a third drop down box 2430 for selecting the duration of time for each data point on the resulting chart (here, “Bi-Weekly” is selected resulting in a data point on the chart for every two weeks of time) and a “Check Review Trend” button 2440. In a first chart, average score on a scale of 1 to 5 (y-axis 2460) is plotted over time (x-axis 2450) for the first and second products selected in boxes 2410 and 2420 resulting in lines 2412 and 2422, respectively. In a second chart, the total number of reviews on an appropriate numeric scale (y-axis 2480) is plotted over time (x-axis 2470) for the first and second products selected in boxes 2410 and 2420 resulting in lines 2414 and 2424, respectively. Not show in 2400, the present invention may also have a date range select input field set, an input to select how many products to compare, and a keyword based product search input to select among a very large set of products. By selecting any point on the line using a computer input device, a popup box can show actual product reviews. This is similar to the system depicted in FIG. 15, the difference being that in this case product reviews are shown. The present invention can also allow the user to create groupings of products, similar to the system presented in FIG. 23 for grouping site traffic data.

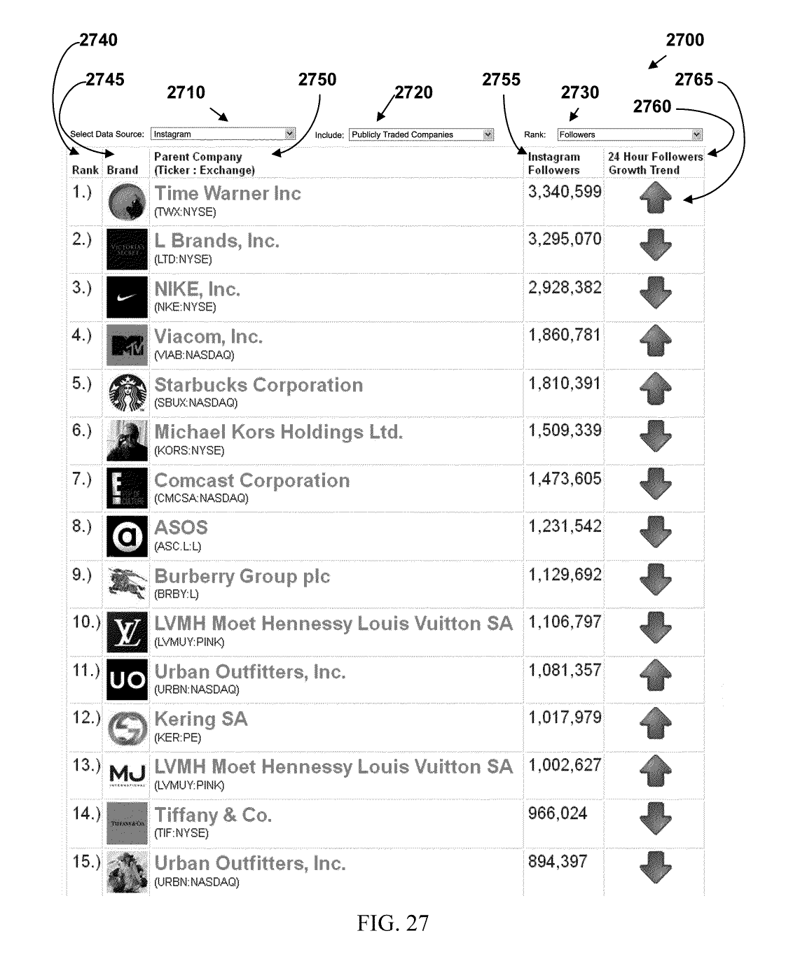

The present invention can have an online social data rank and comparison system 2700 as depicted in FIG. 27. Specifically, system 2700 can have a first dropdown box 2710 that allows the user to select the input. In this example, “Instagram” has been selected. System 2700 can then have dropdown 2720 that allows the user to select the company universe. In this case “Publicly Traded Companies” has been selected. System 2700 can then have dropdown 2730 that allows the user to select the comparison factor. This case, the available factors are determined by what is selected in 2710, via an AJAX call to the database. In this case “Followers” has been selected. Not shown in FIG. 27, the user can also select the relevant time range for the growth trend 2760. The present invention can present the rank, 2740, the associated brand name if any, 2745, the company along with its ticker and exchange, 2750, the absolute value of the item being ranked, 2755, and the growth trend, 2760. The brand 2740 can be displayed as an icon when it is available. When the user rolls over the picture with a computer pointing device, the brand name can be displayed. The growth trend 2760 is calculated as the rate of change of the rate of change. The directional up/down arrows 2765 can be color coded. When the user rolls over the directional arrow with a pointing device, the absolute number can be shown.

Competitive Landscape Analysis

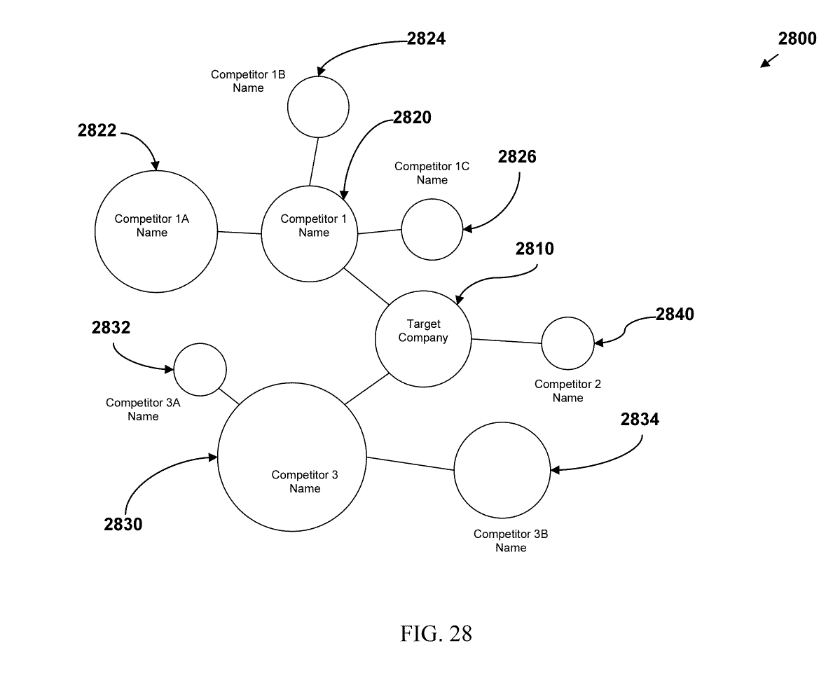

The present invention is can provide a number of tools for competitive analysis and analysis of a target company's competitive landscape. FIG. 28 illustrates the display of a company's competitors and those companies' competitors. Circle 2810 represents the target company selected by the user. Circles 2820, 2830, and 2840 represent the company's competitors as calculated by the present invention. The size of the circle represents the relative size of the competitor. Circles 2822, 2824, and 2826 represent the competitors to 2820. Circles 2832 and 2834 represent the competitors to 2830. These circles are sized in the same manner as 2820, 2830, and 2840. While this illustration shows a particular number of competitors and sub-competitors, the actual number circles and their sizes is determined by the present invention based on the data underlying each company. The associations, as represented by connecting lines between the circles are calculated by first sampling the entire body of consumer generated discussion about each company as is done within system 100, starting with the company 2810. Then the most commonly discussed companies used in the same text are added up. Competitors are identified by keywords entered into the company models. Via the company specific model, keywords are entered to describe the company in searches. The user can also manually override this based on a display of most common word associations. The size of the sub circles can be determined by the relative number of times a competitor is used in the same text as the target company. For display purposes, the average size of the sub circles for the first nodes, represented in illustration 2800 as 2820, 2830, and 2840, can be set to be the same size as the target company circle. Subsequent generations as represented by 2822, 2824, and 2826, for example, can be sized based on their occurrence in discussion of the node, for example 2820, relative to the parent node, 2810 in this example. The process is repeated for each sub-competitor. The user can specify the maximum number of nodes and levels. Other sizing methods, or constant sizing may be utilized.

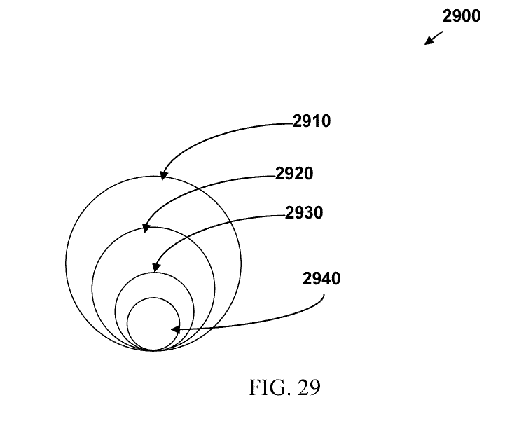

FIG. 29, 2900, illustrates how the present invention can be used to show relative mindshare among consumers of various companies in an industry. In this illustration, there are four companies, represented as 2910, 2920, 2930, and 2940. The size of each circle is determined by the relative amount of discussion about each company. The present invention can either automatically select the competitors shown, by way of the process used in 2800 or the user can enter companies to compare.

Pricing and Availability Monitor

Utilizing system 100, the present invention can be used to build models of pricing and availability of various products and services. Two such examples are airline seats and hotel rooms. The present invention can systematically check pricing and availability by browsing to websites that make these services available. It can then record the pricing, and unit availability count for these products. Over a large number of iterations, this data can then be presented via a state, MSA, or county level map to show which regions are experiencing the most economic activity, and which airlines and hotels are seeing the greatest demand.

Performance Results of the Present Invention

The present invention has been shown to have excellent predictive results both for company revenue and for share price as well as the company's outlook for the coming quarter. For example, in a detailed analysis of 30 liquid, publicly traded companies that reported earnings in October and November of 2013, the present invention accurately predicted the revenue trend that the company would report for the past quarter 94% of the time, it accurately anticipated whether the tone of the company's outlook for the next quarter would be positive, negative, or neutral 79% of the time, and it accurately anticipated the direction of share price movement 76% of the time. Based on the single day of the earnings release, an investor would have generated an average daily return of more than 4% before trading fees. In comparison, the average daily return for the S&P 500 in 2013 through December 10 has been 0.11% before trading fees.

Revenue trends are taken from the period over period relative change in the interest score calculated by the present invention and illustrated, for example, in FIG. 7. Outlook for the coming quarter is taken from the recent slope in the interest score. Share price movement is taken from the absolute score, either stars, or traffic light. For the purpose of this analysis, three score tiers were considered: positive (four and five stars, or green light), neutral (three stars or yellow light), and negative (one or two stars or red). The companies were chosen at random from a pool of companies with adequate data history and market liquidity.

Revenue growth, company outlook, and market sentiment are among the most important drivers of share price. The present invention provides a way to track each of these.

The present invention has also been shown to be highly effective at forecasting and measuring specific category sales including used cars and self storage space. It has also been highly effective at identifying major consumer sentiment issues, such as fears of rising mortgage rates.

Summary

The present invention is a new and novel tool for incorporating social data and other high volume internet data (collectively, “social financial data”) within financial markets. Existing work demonstrates the potential usefulness of social data within financial markets. The present invention makes social financial data broadly useful to technical and non-technical users.

It provides a full infrastructure to map datasets to company and build a social-financial model for specific companies and their underlying stocks and related assets. It robustly collects data. It incorporates multiple and diverse data sources and can readily adapt as more become available. It provides novel scoring systems that synthesize complex data and complex results into a readily usable and useful form. It presents numerous ways to visualize this data. It provides a single platform for users to understand and evaluate multiple inputs. It greatly expands the applicable asset universe to include virtually any publicly traded stock

By combining these multiple capabilities, including numerous new and novel components, and building off existing work, the present invention is an entirely new and novel solution.

An important body of work has been completed demonstrating the potential usefulness of social data in financial markets. The present invention greatly extends this work by addressing a number of problems, including scope, scale, and usability. Through its innovative interface, it provides a practical, and previously unavailable, way for technical and non-technical users to use and understand the information in a profitable investment strategy.

Further, the present invention brings new and novel capabilities and existing work together in a new and novel platform that unifies social-financial information and research. In doing so, it supports a wide range of financial market use cases that previous work does not. These use cases include, but are in no way limited to those presented in Table 6.

TABLE 6
Sample Use Cases

| Use Case | How |
|---|---|
| Identify stock | The present invention provides a rating system, change alerts, and a |
| opportunities and risks | screening tool that automatically highlights companies that present |
| | investment risk and/or opportunities based on the information |
| | revealed in social data and other big data used in conjunction with |
| | social data. This information is presented in an easy to use, widely |
| | understandable format. |
| Predict company revenue | Through the use of the interest score it calculates, the present |
| results | invention provides an effective way to predict company revenue |
| | ahead of the market. |
| Predict company revenue | Similarly, the present invention allows users to successfully predict |
| growth guidance. | the positive or negative nature of company revenue guidance. |
| Predict company share | The present invention can be used alone or in conjunction with other |
| prices | investment tools to successfully predict share prices. |
| Identify company | The present invention monitors company products, services, and |
| product, service and | brands across a wide range of social-financial inputs, and allows |
| brand issues among | users to explore the drivers and trends in each. While there are |
| consumers. | existing tools that monitor services such as Twitter, the present |
| | invention presents novel ways to visualize these, provides a single |
| | platform for exploring these, and ultimately utilizes this data in a |
| | new and novel way to make successful predictions about company |
| | revenue, company outlooks, and share price. |
| Visualize and filter data | The present invention deploys previously invented display and |
| | graphical methodologies in new ways to effectively communicate |
| | and understand the complex messages in very high volume datasets. |
| Measure and understand | This is a capability found in existing work. The present invention |
| investor sentiment. | allows users to work with this information in the context of other |
| | factors, such as sentiment about the company's products, services, |
| | and brands. |
| Construct investment | The tools within the present invention provide a new way for users |
| portfolios | to construct investment portfolios. |
| Understand company and | The present invention also provides a number of ways for |
| investment drivers | investment professionals to understand the drivers of sales trends at |
| | companies. For example, it is highly effective at measuring and |
| | revealing factors such as discounting, competitive activity, customer |
| | dissatisfaction along with the underlying reasons, and so on. |

In addition there are a wide range of use cases outside of stock and related asset investing. These include, but are in no way limited to those presented in Table 7.

TABLE 7
Other Sample Use Cases

| Use Case | How |
|---|---|
| Competitive analysis | The present invention can be used for competitive analysis. It can |
| | be used to compare competitors in a market and it can be used for |
| | one company in a sector to gain a better understanding of another. |
| | This has broad application to corporate strategy, marketing, and |
| | sales. |
| Identify competitors | The present invention, as illustrated in 2800 and 2900 can be used to |
| | identify who a company's actual competitors are in the eyes of |
| | consumers. This often differs from the competitors mapped using |
| | standard industry classifications, and can be very useful to investors |
| | and marketers. |
| Understand real estate | The present invention can be used to compare real estate markets |
| market trends | and trends. It can identify, for example, which types of homes are |
| | most profitable to build and what types of homes consumers will |
| | want. It can also measure relative market strength by geographic |
| | location, including state, metropolitan statistical area (MSA), county |
| | and zip code. |
| Measure and predict | The present invention can measure and forecast overall retail sales |
| overall retail sales | more accurately and more cheaply than widely used tools. |
| Measure and predict | The present invention can be used to accurately measure and predict |
| specific category sales | sales trends in specific categories. Specific examples include, but |
| | are not limited to measurements of and predictions of used car sales, |
| | self storage space sales, movies box office sales, video games, book |
| | sales, and recording sales. Further the present invention provides a |
| | practical way for users to understand the drivers behind these. |
| Consumer trend analysis | The present invention is well suited to identify and monitor |
| | consumer trends. It can also answer questions about consumers that |
| | would traditionally be done with survey data. For example, an |
| | investor could get an answer to the question “Are potential home |
| | buyers worried that interest rates will rise?” |
| Measure company social | The present invention can readily measure the amount of marketing |
| media marketing levels | that specific companies are doing via social media. The present |
| | invention can also measure how much social media reach the |
| | company has. |
| Monitor SEC filing | The present invention provides a way for users to easily watch |
| changes | changes in most commonly used words in key sections of SEC |
| | filings. This can alert users to important changes in areas including, |
| | but not limited to the company's profile, its litigation issues, and its |
| | disclosures. |
| Rank companies and | The present invention can be used to rank companies and brands |
| brands based on social | based on social data inputs. For example, FIG. 27 illustrates |
| data inputs | publicly traded company brands ranked by Instagram followers. |
| | This can be useful to understand which brands are most valuable, |
| | and which are growing and which are shrinking It can also be used |
| | to identify, measure, and identify the social media influence of |
| | specific companies. This is useful for purposes including measuring |
| | the marketing effectiveness of specific companies. |

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. Moreover, it should be recognized that the stages could be implemented in hardware, firmware, software or any combination thereof.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

I claim:

1. A computer implemented method comprising:
on a device having one or more processors and a memory storing one or more programs for execution by the one or more processors, the one or more programs including instructions for:
collecting data from an information source regarding a target;
generating a signal related to the target based on the collected data; and
transmitting the signal.

2. The method of claim 1, the method further comprising:
parsing the data; and
scoring the data,
wherein the generating is based on the parsed and scored data.

3. The method of claim 1, wherein the information source comprises one from the group consisting of a social media website, Twitter, Facebook, Instagram, Pinterest, YouTube, LinkedIn, Google Plus+, Tumblr, blogs, discussion forums, review sites, site traffic and search engine trend data.

4. The method of claim 1, wherein the target comprises one from the group consisting of a security, a publicly traded security, a company, an organization, a product, a service, real property, a vehicle, a new automobile, a used automobile, audiovisual content, a website, a movie, a television show, a song, a publication, a book, a magazine and a newspaper.

5. The method of claim 1, wherein the signal comprises one from the group consisting of a social data trend indicator, a sentiment score, a star rating, a traffic light indicator, a linear score, a composite score, a chart having an x-axis and a y-axis, a trend line, an indexed trend line, a gauge, a meter, a sentiment gauge, a sentiment meter, a color coded indicator, an alert, a text radial, an interactive text radial, a pop up window, a window with tabs, a word cluster, a heat map and a color coded map.

6. The method of claim 1, wherein the signal is based on a calculation based on one from the group consisting of social data, news data, transaction based data, company disclosed data and market data,
wherein the calculation is one from the group consisting of a growth rate, a sentiment, a sentiment ratio and an influence score.

7. The method of claim 1, wherein the signal is a user alert, and the user alert comprises one from the group consisting of a change in a calculated score, an anticipated change in a revenue trend for the target, a change in a sentiment of a discussion about the target's underlying products based on a calculation, a change in a volume of a discussion relating to the target, a change in a calculated interest in the target, a change in a tone of news headlines relating to the target, a change in a volume of news headlines relating to the target, a drop or increase in site traffic relating to the target relative to a calculated expectation, a changes in a calculated expectation of a litigation risk based on a litigation section of a recent SEC filing related to the target, and an upcoming earnings release.

8. The method of claim 2, wherein the parsing comprises prompting a user to select one or more basic terms; and parsing company generated text and website keywords for words and phrases that are unique to the one or more basic terms.

9. The method of claim 8, wherein the parsing comprises a process of collecting information regarding an other target, comparing information relating to the target with information relating to the other target, and identifying words and phrases which are most unique to the target relative to the other target.

10. The method of claim 2, wherein the scoring comprises prompting a user to score a sentiment and a relevance of an individual piece of information from the parsed data.

11. The method of claim 2, wherein the scoring comprises:
developing a descriptive model for the target;
generating a factor based on the descriptive model;
normalizing the factor using a standard statistical technique;
prompting a user to select a factor;
prompting the user to select a weight or a lag for the selected factor; and
calculating a score based on the selected weight or lag for the selected factor.

12. The method of claim 11, wherein the factor comprises one from the group consisting of volume of social media output, count of social media output, Facebook likes, a sentiment score for text based data, average sentiment, a ratio of sentiment, positive sentiment, negative sentiment, a sentiment scoring parameter for the target, a sentiment scoring parameter for a topic related to the target, a rate of change, a change relative to the target's competitor, and an intermediate computed factor.

13. The method of claim 1, wherein the transmitting comprises transmitting an image comprising a name of the target, a ticker symbol corresponding to the target, a share price relating to the target, a social data trend relating to the target based on a score generated by the scoring, a traffic light signal and a composite score over time based on a score generated by the scoring expressed as a line on a chart.

14. The method of claim 1, wherein the transmitting comprises transmitting an image comprising a name of the target, a ticker symbol corresponding to the target, a share price relating to the target, a social data trend relating to the target based on a score generated by the scoring, a traffic light signal and a sentiment gauge.

15. The method of claim 1, wherein the transmitting comprises transmitting an image comprising a name of the target, a ticker symbol corresponding to the target and a star rating for the target based on the scoring.

16. The method of claim 1, wherein the transmitting comprises transmitting an image comprising a name of the target, an interest score for the target, a system generated alert, a meter, a model input explorer and a current discussion explorer.

17. The method of claim 1, wherein the transmitting comprises transmitting an image comprising a text radial related to the target, wherein the text radial is interactive and is adapted to allow a user to click on a portion of the text radial to obtain additional information regarding one or more subjects presented in the text radial.

18. The method of claim 1, wherein the transmitting comprises transmitting an image comprising a stock price chart related to the target, wherein the stock price chart is interactive and is adapted to allow a user to click on a portion of the stock price chart to obtain additional information regarding one or more subjects presented in the stock price chart at a particular point in time.

19. A computer system comprising:
one or more processors; and
memory to store:
one or more programs, the one or more programs comprising instructions for:
collecting data from an information source regarding a target;
generating a signal related to the target based on the collected data; and
transmitting the signal.

20. A non-transitory computer-readable storage medium storing one or more programs configured to be executed by one or more processing units at a computer comprising:
instructions for:
collecting data from an information source regarding a target;
generating a signal related to the target based on the collected data; and
transmitting the signal.
